(19) United States
(12) Patent Application Publication
(10) Pub. No.: US 2026/0222630 A1
(43) Pub. Date: Jul. 30, 2026

(54) METHOD, APPARATUS AND SYSTEM FOR ENCODING AND DECODING A TENSOR

(71) Applicant: CANON KABUSHIKI KAISHA, Tokyo (JP)

(72) Inventor: Christopher James ROSEWARNE, Concord (AU)

(21) Appl. No.: 19/146,116

(22) PCT Filed: Dec. 13, 2023
(86) PCT No.: PCT/AU2023/051295

§ 371 Date: Jul. 7, 2025

(30) Foreign Application Priority Data
Jan. 10, 2023 (AU) 2023200118

(51) Int. Cl. H04N 19/88; H04N 19/30

(52) U.S. Cl. CPC H04N 19/88; H04N 19/30

(57) ABSTRACT

A method of encoding a tensor for a single frame into a bitstream, and a corresponding method of decoding the tensor from the bitstream. The encoding method comprises producing coefficients for the tensor using a plurality of basis vectors, the coefficients forming one feature map for each basis vector of the plurality of basis vectors; and producing an assignment that groups coefficients according to the respective one of the basis vector for the coefficients. The encoding method further comprises encoding the coefficients into a feature frame bitstream such that each group of coefficients is decoded independently; and encoding the assignment into the bitstream and setting a subpicture arrangement based on the assignment to encode the tensor.

### TECHNICAL FIELD

This application claims the benefit under 35 U.S.C. § 119 of the filing date of Australian Patent Application No. 2023200118, filed 10 Jan. 2023, hereby incorporated by reference in its entirety as if fully set forth herein.

### TECHNICAL FIELD

The present invention relates generally to digital video signal processing and, in particular, to a method, apparatus and system for encoding and decoding tensors from a convolutional neural network. The present invention also relates to a computer program product including a computer readable medium having recorded thereon a computer program for encoding and decoding tensors from a convolutional neural network using video compression technology.

### BACKGROUND

Convolutional neural networks (CNNs) are an emerging technology addressing, among other things, use cases involving machine vision such as object detection, instance segmentation, object tracking, human pose estimation, and action recognition. Applications for CNNs can involve use of ‘edge devices’, with sensors and some processing capability, coupled to application servers as part of a ‘cloud’. CNNs can require relatively high computational complexity, more than can typically be afforded either in computing capacity or power consumption by an edge device. Executing a CNN in a distributed manner has emerged as one solution to running leading edge networks using limited capability edge devices without pushing all computational complexity into cloud servers. In other words, distributed processing allows legacy edge devices to still provide the capability of leading edge CNNs by distributing processing between the edge device and external processing means, such as cloud servers. Such a distributed network architecture may be referred to as ‘collaborative intelligence’ (CI) and offers benefits such as re-using a partial result from a first portion of the network with several different second portions, perhaps each portion being optimised for a different task. CI architectures introduce a need for efficient compression of tensor data, for transmission over a network such as a WAN.

CNNs typically include many layers, such as convolution layers and fully connected layers, with data passing from one layer to the next in the form of ‘tensors’. Splitting a network across different devices introduces a need to compress the intermediate multi-dimensional tensor data that passes from one layer to the next within a CNN. Compression of such tensors may be referred to as ‘feature compression’, as the intermediate tensor data is often termed as ‘features’ or ‘feature maps’ (generally a collection of 2D ‘feature maps’ forming a tensor and each feature map corresponding to one ‘channel’) and represents a partially processed form of input such as an image frame or video frame. International Organisation for Standardisation/International Electrotechnical Commission Joint Technical Committee 1/Subcommittee 29/Working Groups 2-8 (ISO/IEC JTC1/SC29/WG2-8), also known as the “Moving Picture Experts Group” (MPEG) are tasked with studying compression technology in various contexts and often in relation to video. WG2 ‘MPEG Technical Requirements’ has established a ‘Video Coding for Machines’ (VCM) ad-hoc group, mandated to study compression for machine consumption and feature compression. The feature compression mandate is in an exploratory phase with a ‘Call for Evidence’ (CfE) issued soliciting technology that can significantly outperform feature compression results achieved using state-of-the-art standardised technology.

CNNs typically require weights for each of the layers to be predetermined in a training stage, where a very large amount of training data is passed through the CNN and a result determined by the network undergoing training being compared to ground truth associated with the training data. Discrepancy between the obtained and desired result is expressed as a ‘loss’ and measured with a ‘loss function’. Using the determined loss a process for updating network weights, such as stochastic gradient descent (SGD), is performed. Network weight update typically involves a back-propagation of ‘gradients’, indicative of deltas to be applied to network weights, beginning at the output layer of the network and terminating when the input layer to the network, and covering intermediate, or ‘hidden’, layers of the network. The rate of weight update is scaled by a ‘learning rate’ hyperparameter, typically set to facilitate the training process in finding a global minima in terms of loss (i.e., highest possible task performance for the network architecture and training data) while avoiding the training process becoming ‘stuck’ in a local minima. Becoming stuck in a local minima corresponds to obtaining sub-optimal task performance for the network architecture and being incapable of finding new weight values that could lead to higher task performance. Network weights are repeatedly updated by supplying input data and ground truth data organised into ‘batches’ to iteratively refine the network performance until further improvements accuracy are no longer achievable. An iteration of the entire training dataset forms an ‘epoch’ of training, and training typically requires multiple epochs to achieve a high level of performance for the task. A trained network is then available for deployment, operating in a mode where weights are fixed and gradients for weight update are omitted. The process of executing a pretrained CNN with an input and progressively transforming the input into an output according to a topology of the CNN is commonly referred to as ‘inferencing’.

Generally, a tensor has four dimensions, namely: batch, channels, height and width. The first dimension, ‘batch’, is typically of size one when inferencing on video data and indicates that one frame is passed through a CNN as one batch. When training a network, the value of the batch dimension may be increased so that multiple frames are passed through the network in each batch before the network weights are updated, according to a predetermined ‘batch size’. A multi-frame video may be passed through as a single tensor with the batch dimension increased in size according to the number of frames of a given video. However, for practical considerations relating to memory consumption and access, inferencing on video data is typically performed on a frame-wise basis. The ‘channels’ dimension indicates the number of concurrent ‘feature maps’ for a given tensor and the height and width dimensions indicate the size of the feature maps at the particular stage of the CNN. Channel count varies through the layers of a CNN according to the network architecture. Feature map size also varies, depending on subsampling or upsampling occurring in specific network layers.

The overall complexity of the CNN tends to be relatively high, with relatively large numbers of multiply-accumulate (MAC) operations being performed and numerous intermediate tensors being written to and read from memory, along with reading weights for performance of each layer of the CNN. As such, dividing a neural network into portions allows such implementation of more complex networks even in less capable edge devices.

Feature compression may benefit from existing video compression standards, such as Versatile Video Coding (VVC), developed by the Joint Video Experts Team (JVET). VVC is anticipated to address ongoing demand for ever-higher compression performance, especially as video formats increase in capability (for example, with higher resolution and higher frame rate) and to address increasing market demand for service delivery over WANs, where bandwidth costs are relatively high. VVC is implementable in contemporary silicon processes and offers an acceptable trade-off between achieved performance versus implementation cost. The implementation cost may be considered for example, in terms of one or more of silicon area, CPU processor load, memory utilisation and bandwidth. Other video compression standards, such as High Efficiency Video Coding (HEVC) or AV-1, may also be used for feature compression applications.

Video data includes a sequence of frames of image data, each frame including one or more colour channels. Where feature map data is to be represented in a packed frame, generally a monochrome frame having luminance only and no chroma channels is adequate. When only luma samples are present, the resulting monochrome frames are said to use a “4:0:0 chroma format”.

The VVC standard specifies a ‘block based’ architecture, in which frames are firstly divided into an array of square regions known as ‘coding tree units’ (CTUs). In VVC, CTUs generally occupy 128×128 luma samples. Other possible CTU sizes when using the VVC standard are 32×32 and 64×64. However, CTUs at the right and bottom edge of each frame may be smaller in area, with implicit splitting occurring the ensure coding blocks remain in the frame. Associated with each CTU is a ‘coding tree’ defining a decomposition of the area of the CTU into a set of blocks, also referred to as ‘coding units’ (CUs). Blocks applicable to only the luma channel or only the chroma channels are referred to as ‘coding blocks’ (CBs). A prediction of the contents of a coding block is held in a ‘prediction block’ (PB) or ‘prediction unit’ (PU) and a residual block defining an array of sample values to be additively combined with the PB or PU is referred to as a ‘transform block’ (TB) or ‘transform unit’ (TU), owing to the typical use of a transformation process in the generation of the TB or TU.

Notwithstanding the above distinction between ‘units’ and ‘blocks’, the term ‘block’ may be used as a general term for areas or regions of a frame for which operations are applied to all colour channels.

For each CU, a prediction unit (PU) of the contents (sample values) of the corresponding area of frame data is generated (a ‘prediction unit’). Further, a representation of the difference (or ‘spatial domain’ residual) between the prediction and the contents of the area as seen at input to the encoder is formed. The difference in each colour channel may be transformed and coded as a sequence of residual coefficients, forming one or more TUs for a given CU. The applied transform may be a Discrete Cosine Transform (DCT) or other transform, applied to each block of residual values. The transform is applied separably, (i.e., the two-dimensional transform is performed in two passes, one horizontally and one vertically). The block is firstly transformed by applying a one-dimensional transform to each row of samples in the block. Then, the partial result is transformed by applying a one-dimensional transform to each column of the partial result to produce a final block of transform coefficients that substantially decorrelates the residual samples. Transforms of various sizes are supported by the VVC standard, including transforms of rectangular-shaped blocks, with each side dimension being a power of two. Transform coefficients are quantised for entropy encoding into a bitstream.

PBs or PUs in VVC may be generated using either an intra-frame prediction or an inter-frame prediction process. Intra-frame prediction involves the use of previously processed samples in a frame being used to generate a prediction of a current block of data samples in the frame. Inter-frame prediction involves generating a prediction of a current block of samples in a frame using a block of samples obtained from one or two previously decoded frames. The block of samples obtained from a previously decoded frame is offset from the spatial location of the current block according to a motion vector, which often has filtering applied. Intra-frame prediction blocks can be (i) a uniform sample value (“DC intra prediction”), (ii) a plane having an offset and horizontal and vertical gradient (“planar intra prediction”), (iii) a population of the block with neighbouring samples applied in a particular direction (“angular intra prediction”) or (iv) the result of a matrix multiplication using neighbouring samples and selected matrix coefficients.

VVC may be used to compress intermediate feature maps from a first portion (a ‘backbone’) of a neural network separated into two portions. In compression, the feature maps from the backbone are arranged into a frame and quantised from a floating-point domain to a sample domain suitable for compression as video data. To reduce the spatial area of the feature maps, additional neural network layers may be implemented at the interface between the VVC encoder and decoder and the intermediate point in the CNN at which the splitting occurs. Training for such additional network layers that may not be suitable for varied and unpredictable encountered feature map data. The training may not result in a CNN having adaptability to operating points of various quality in terms of task performance. The operating point of the encoder and decoder may also vary during operation, with a need to support varying quality levels of the reconstructed tensors to be supplied to the remainder of the network at the decoder side.

### SUMMARY

It is an object of the present invention to substantially overcome, or at least ameliorate, one or more disadvantages of existing arrangements.

One aspect of the present disclosure provides a method of encoding a tensor for a single frame into a bitstream, the method comprising: producing coefficients for the tensor using a plurality of basis vectors, the coefficients forming one feature map for each basis vector of the plurality of basis vectors; producing an assignment that groups coefficients according to the respective one of the basis vector for the coefficients; encoding the coefficients into a feature frame bitstream such that each group of coefficients is decoded independently; and encoding the assignment into the bitstream and setting a subpicture arrangement based on the assignment to encode the tensor.

Another aspect of the present disclosure provides a method of decoding a tensor for a single frame from a bitstream, the method comprising: decoding an assignment that maps an arrangement of independently coded regions of a picture to a plurality of groups of basis vectors; decoding a feature frame from the bitstream wherein the feature frame contains a plurality of independently coded regions, each region containing coefficients corresponding to one or more basis vectors of a plurality of basis vectors according to the assignment; obtaining coefficients from the decoded feature frame by inverse quantising samples from the feature frame; and producing the decoded tensor using the basis vectors and the decoded coefficients.

Another aspect of the present disclosure provides an encoder for encoding a tensor for a single frame into a bitstream, the method comprising: producing coefficients for the tensor using a plurality of basis vectors, the coefficients forming one feature map for each basis vector of the plurality of basis vectors; producing an assignment that groups coefficients according to the respective one of the basis vector for the coefficients; encoding the coefficients into a feature frame bitstream such that each group of coefficients is decoded independently; and encoding the assignment into the bitstream and setting a subpicture arrangement based on the assignment to encode the tensor.

Another aspect of the present disclosure provides a non-transitory computer-readable storage medium which stores a program for executing a method of encoding a tensor for a single frame into a bitstream, the method comprising: producing coefficients for the tensor using a plurality of basis vectors, the coefficients forming one feature map for each basis vector of the plurality of basis vectors; producing an assignment that groups coefficients according to the respective one of the basis vector for the coefficients; encoding the coefficients into a feature frame bitstream such that each group of coefficients is decoded independently; and encoding the assignment into the bitstream and setting a subpicture arrangement based on the assignment to encode the tensor.

Another aspect of the present disclosure provides system comprising: a memory; and a processor, wherein the processor is configured to execute code stored on the memory for implementing a method of encoding a tensor for a single frame into a bitstream, the method comprising: producing coefficients for the tensor using a plurality of basis vectors, the coefficients forming one feature map for each basis vector of the plurality of basis vectors; producing an assignment that groups coefficients according to the respective one of the basis vector for the coefficients; encoding the coefficients into a feature frame bitstream such that each group of coefficients is decoded independently; and encoding the assignment into the bitstream and setting a subpicture arrangement based on the assignment to encode the tensor.

Another aspect of the present disclosure provides a decoder for decoding a tensor for a single frame from a bitstream, the decoder configured to: decode an assignment that maps an arrangement of independently coded regions of a picture to a plurality of groups of basis vectors; decode a feature frame from the bitstream wherein the feature frame contains a plurality of independently coded regions, each region containing coefficients corresponding to one or more basis vectors of a plurality of basis vectors according to the assignment; obtain coefficients from the decoded feature frame by inverse quantising samples from the feature frame; and produce the decoded tensor using the basis vectors and the decoded coefficients.

Another aspect of the present disclosure provides a non-transitory computer-readable storage medium which stores a program for executing a method of decoding a tensor for a single frame from a bitstream, the method comprising: decoding an assignment that maps an arrangement of independently coded regions of a picture to a plurality of groups of basis vectors; decoding a feature frame from the bitstream wherein the feature frame contains a plurality of independently coded regions, each region containing coefficients corresponding to one or more basis vectors of a plurality of basis vectors according to the assignment; obtaining coefficients from the decoded feature frame by inverse quantising samples from the feature frame; and producing the decoded tensor using the basis vectors and the decoded coefficients.

Another aspect of the present disclosure provides a system comprising: a memory; and a processor, wherein the processor is configured to execute code stored on the memory for implementing a method of decoding a tensor for a single frame from a bitstream, the method comprising: decoding an assignment that maps an arrangement of independently coded regions of a picture to a plurality of groups of basis vectors; decoding a feature frame from the bitstream wherein the feature frame contains a plurality of independently coded regions, each region containing coefficients corresponding to one or more basis vectors of a plurality of basis vectors according to the assignment; obtaining coefficients from the decoded feature frame by inverse quantising samples from the feature frame; and producing the decoded tensor using the basis vectors and the decoded coefficients.

Other aspects are also disclosed.

### BRIEF DESCRIPTION OF THE DRAWINGS

At least one embodiment of the present invention will now be described with reference to the following drawings and an appendix, in which:

FIG. 1 is a schematic block diagram showing a distributed machine task system;

FIGS. 2A and 2B form a schematic block diagram of a general-purpose computer system upon which the distributed machine task system of FIG. 1 may be practiced;

FIG. 3A is a schematic block diagram showing functional modules of a backbone portion of a CNN;

FIG. 3B is a schematic block diagram showing a residual block of FIG. 3A;

FIG. 3C is a schematic block diagram showing a residual unit of FIG. 3A;

FIG. 3D is a schematic block diagram showing a CBL module of FIG. 3A;

FIG. 4 is a schematic block diagram showing functional modules of an alternative backbone portion of a CNN;

FIG. 5 is a schematic block diagram showing a multi-scale feature fusion stage;

FIG. 6 is a schematic block diagram showing an inter-channel decorrelation-based tensor encoder as part of a distributed machine task system;

FIG. 7 is a schematic block diagram showing a feature map packer, packed frame encoder, and unpacker (or ‘subpicture encoder’) as part of an inter-channel decorrelation-based tensor encoder;

FIG. 8 is a schematic block diagram showing functional modules of a video encoder;

FIG. 9 is a schematic block diagram showing an inter-channel decorrelation-based tensor decoder as part of a distributed machine task system;

FIG. 10 is a schematic block diagram showing functional modules of a video decoder;

FIGS. 11A and 11B are schematic block diagrams showing embodiments of a multi-scale feature reconstruction stage;

FIG. 12A is a schematic block diagrams showing a head portion of a CNN;

FIG. 12B is a schematic block diagram showing an upscaler module of FIG. 10A;

FIG. 12C is a schematic block diagram showing a detection module of FIG. 10A;

FIG. 13 is a schematic block diagram showing an alternative head portion of a CNN;

FIGS. 14A & 14B are schematic block diagrams showing an arrangement of subpictures for holding inter-channel decorrelated tensor data;

FIG. 15 is a schematic block diagram showing a bitstream holding encoded inter-channel decorrelated feature maps and associated metadata;

FIG. 16 shows a method for performing a first portion of a CNN, decorrelating, and encoding resulting feature maps; and

FIG. 17 shows a method for decoding a bitstream, reconstructing decorrelated feature maps, and performing a second portion of the CNN.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

A distributed machine task system may include an edge device, such as a network camera or smartphone producing intermediate compressed data. The distributed machine task system may also include a final device, such as a server farm based (‘cloud’) application, operating on the intermediate compressed data to produce a task result. Additionally, the edge device functionality may be embodied in the cloud and the intermediate compressed data may be stored for later processing, potentially for multiple different tasks depending on need.

A convenient form of intermediate compressed data is a compressed video bitstream, owing to the availability of high-performing compression standards and implementations thereof. Video compression standards typically operate on integer samples of some given bit depth, such as 10 bits, arranged in planar arrays. Colour video has three planar arrays, corresponding, for example, to colour components Y, Cb, Cr, or R, G, B, depending on application. CNNs typically operate on floating point data in the form of tensors. Tensors generally have a relatively smaller spatial dimensionality compared to incoming video data upon which the CNN operates while having more channels than the three channels typical of colour video data, for example 128, 256, or 512 channels.

Tensors typically have the following dimensions: frames, channels, height, and width. For example, a tensor of dimensions [1, 256, 76, 136] would be said to contain data for one frame comprising two-hundred and fifty-six (256) feature maps (channels), each of size 136×76. For video data, inferencing is typically performed one frame at a time (frame value of 1), rather than using tensors containing multiple frames.

VVC supports a division of a picture into multiple subpictures, each of which may be independently encoded and independently decoded. In one approach, each subpicture is coded as one ‘slice’, or contiguous sequence of coded CTUs. A ‘tile’ mechanism is also available to divide a picture into a number of independently decodeable regions. Subpictures may be specified in a somewhat flexible manner, with various rectangular sets of CTUs coded as respective subpictures. Flexible definition of subpicture dimensions allows efficiently holding types of data requiring different areas in one picture, avoiding large ‘unused’ areas, i.e., areas of a frame that are not used for reconstruction of tensor data.

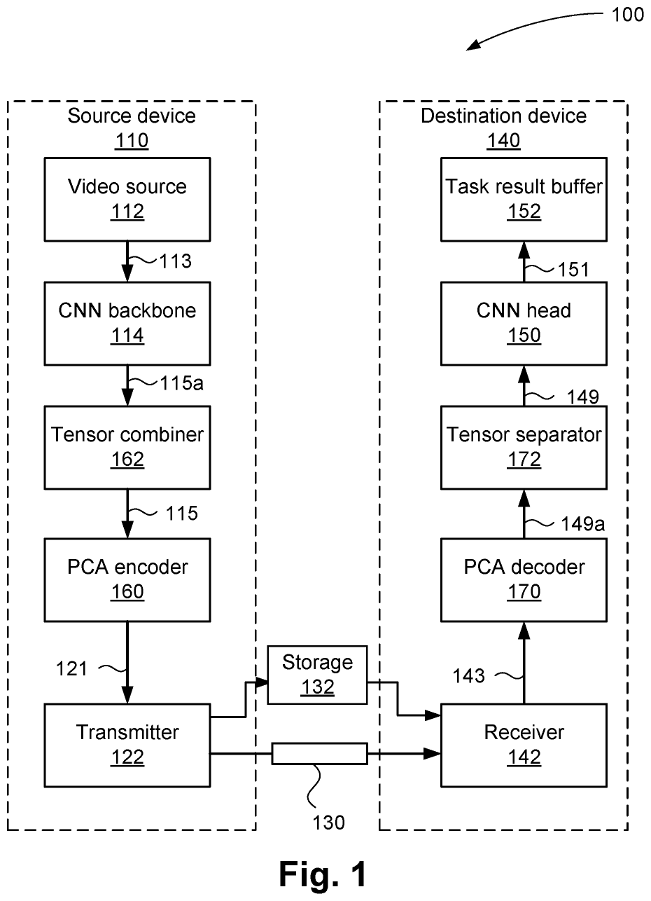

FIG. 1 is a schematic block diagram showing functional modules of a distributed machine task system 100, capable of performing a machine task network in a distributed manner. The division of a particular neural network into two portions requires specifying a ‘split point’ in the network. Layers in the network from the input layer up to the split point are performed in a first device and the resulting intermediate tensor(s) are compressed. Layers from the split point up to the last layer in the network are performed using decompressed tensor(s) from the first device as input to the layer(s) immediately following the split point. At the split point there may be one or more tensors that need to be compressed for conveyance over a communication channel with limited bandwidth compared to the bandwidth requirement for transmission of uncompressed tensors. Where a ‘feature pyramid network’ (FPN) is in use, it is common for layers in the FPN to be related in width and height such that a given layer is half the width and height of an adjacent layer among the layers. FPN architectures may also define the width and height halving to occur on every alternate layer. In some architectures, multiple tensors of the same width and height are seen. A network may be split within the FPN of the machine task network, facilitating performance of a variety of machine task networks where layers up to the split point are common among them (‘shared backbone’ architecture). Compression methods applicable to the various network topologies used in contemporary CNNs are therefore beneficial for application to a wide range of scenarios.

The system 100 may be used for implementing methods for decorrelating, packing and quantising feature maps into planar frames for encoding and decoding feature maps from encoded data. The system 100 can be used in some embodiments such that bitrate of the compressed tensors is rate controllable with quality of the reconstructed tensor varying based on the selected rate. The system 100 can also be used in some embodiments such that the quantised representation of the tensors does not needlessly consume bits where the bits do not provide a commensurate benefit in terms of task performance.

The system 100 includes a source device 110 for generating encoded tensor data 115a from a CNN backbone 114 in the form of encoded video bitstream 121. The system 100 also includes a destination device 140 for decoding tensor data in the form of an encoded video bitstream 143. A communication channel 130 is used to communicate the encoded video bitstream 121 from the source device 110 to the destination device 140. In some arrangements, the source device 110 and destination device 140 may either or both comprise respective mobile telephone handsets (e.g., “smartphones”) or network cameras and cloud applications. The communication channel 130 may be a wired connection, such as Ethernet, or a wireless connection, such as WiFi or 5G, including connections across a Wide Area Network (WAN) or across ad-hoc connections. Moreover, the source device 110 and the destination device 140 may comprise applications where encoded video data is captured on some computer-readable storage medium, such as a hard disk drive in a file server or memory.

As shown in FIG. 1, the source device 110 includes a video source 112, the CNN backbone 114, a tensor combiner 162, a principal component analysis (PCA) encoder 160, and a transmitter 122. The video source 112 typically comprises a source of captured video frame data (shown as 113), such as an image capture sensor, a previously captured video sequence stored on a non-transitory recording medium, or a video feed from a remote image capture sensor. The video source 112 may also be an output of a computer graphics card, for example, displaying the video output of an operating system and various applications executing upon a computing device (e.g., a tablet computer). Examples of source devices 110 that may include an image capture sensor as the video source 112 include smart-phones, video camcorders, professional video cameras, and network video cameras. The video source 112 may produce independent images or may produce temporally sequential images, i.e., a video.

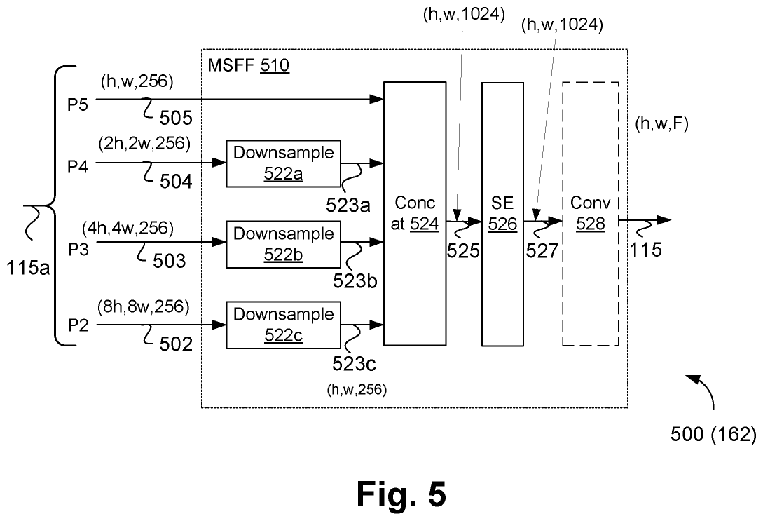

The CNN backbone 114 receives the video frame data 113 and performs specific layers of an overall CNN, such as layers corresponding to the ‘backbone’ of the CNN, outputting tensors 115a. The backbone layers of the CNN may produce multiple tensors as output, for example, corresponding to different spatial scales of an input image represented by the video frame data 113 when splitting the network within the FPN. An FPN may result in three tensors, corresponding to three layers, output from the backbone 114 as the tensors 115a, for example if a ‘YOLOv3’ network is performed by the system 100, with varying spatial resolution and channel count. When the system 100 is performing networks such as ‘Faster RCNN X101-FPN” or “Mask RCNN X101-FPN” the tensors 115a may include tensors for four layers (P2-P5). Use of a FPN results in a plurality of tensors forming a hierarchical representation for a single frame to be encoded to (and decoded from) the bitstream when the split point of the network occurs within the FPN, as described hereafter. The tensor combiner 162 may combine multiple layers by performing convolutions with a stride of greater than one, such as a stride of two, to implement a trained downsampling stage, resulting in a tensor with the same dimensions as another, spatially smaller, tensor among the plurality of tensors 115a. The resulting set of tensors, all having the same spatial dimensions, may be concatenated along the channel dimension and further processed by additional network layers producing combined tensor 115. Operation of the tensor combiner is described with reference to FIG. 5. The PCA encoder 160 receives combined tensor 115, output from the tensor combiner 162. The combining of layers is suitable when sufficient inter-layer correlation exists for the combined layer to be represented using fewer basis vectors than would be required were the layers to be separately decorrelated. The degree of inter-layer correlation is a property of the network itself and the provided input data. The degree of inter-layer correlation permits a reduction in the total number of basis vectors for the combined tensor compared to the sum of the number of basis vectors were tensors of each layer separately decorrelated. For example, if ordinarily using 25 basis vectors per layer, and concatenating two layers, the number of basis vectors needed by two concatenated layers may be set at less than 50 and the number of basis vectors needed by four concatenated layers may be set at less than 100.

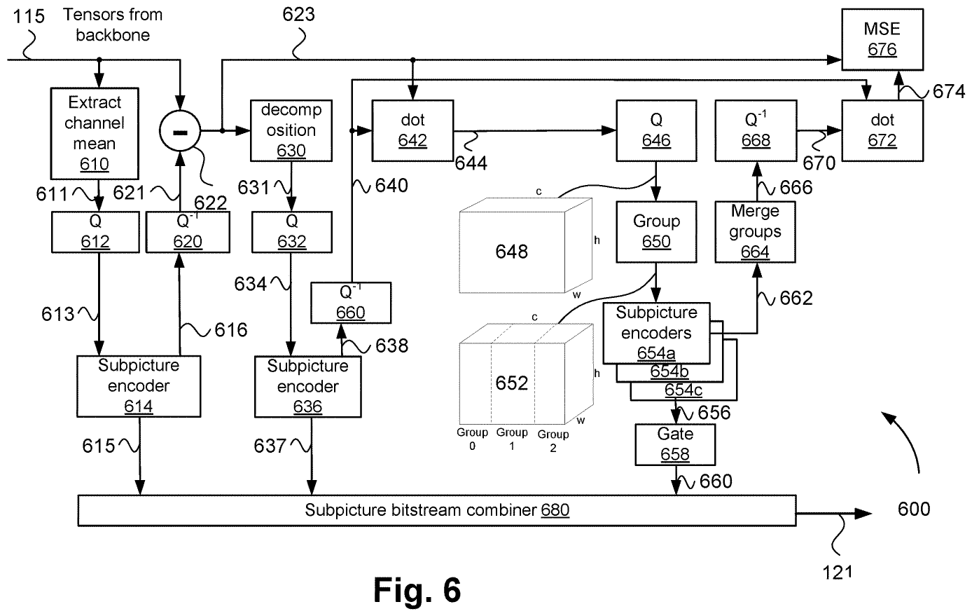

The PCA encoder 160 acts to encode the combined tensor 115 to produce the bitstream 121 and is described with reference to FIG. 6. The bitstream 121 is supplied to the transmitter 122 for transmission over the communications channel 130 or the bitstream 121 is written to storage 132 for later use.

The source device 110 supports a particular network for the CNN backbone 114. However, the destination device 140 may use one of several networks for a head CNN 150. In using one of several networks for the head CNN 150, partially processed data in the form of packed feature maps may be stored for later use in performing various tasks without needing to again perform the operation of the CNN backbone 114.

The bitstream 121 is transmitted by the transmitter 122 over the communication channel 130 as encoded video data (or “encoded video information”). The bitstream 121 can in some implementations be stored in a storage memory 132, where the storage 132 is a non-transitory storage device such as a “Flash” memory or a hard disk drive, until later being transmitted over the communication channel 130 (or in-lieu of transmission over the communication channel 130). For example, encoded video data may be served upon demand to customers over a wide area network (WAN) for a video analytics application.

The destination device 140 includes a receiver 142, a PCA decoder 170, a tensor separator 172, a CNN head 150, and a CNN task result buffer 152. The receiver 142 receives encoded video data from the communication channel 130 and passes the video bitstream 143 to the PCA decoder 170. The PCA decoder 170 outputs a decoded combined tensor 149a, which is supplied to the tensor separator 172. The tensor separator 172 performs the inverse operation of the tensor combiner 162, to produce extracted tensors 149. The extracted tensors 149 are passed to the CNN head 150. In split points where the network is divided at a stage with a single tensor combining of layers is not required, the tensor separator 172 does not perform any operation and the tensors 149 correspond to the tensor 149a. The CNN head 150 performs the later layers of the task that began with the CNN backbone 114 to produce a task result 151. The task result 151 is stored in the task result buffer 152. The contents of the task result buffer 152 may be presented to the user, e.g. via a graphical user interface, or provided to an analytics application where some action is decided based on the task result, which may include summary level presentation of aggregated task results to a user. It is also possible for the functionality of each of the source device 110 and the destination device 140 to be embodied in a single device, examples of which include mobile telephone handsets and tablet computers and cloud applications. While the examples described herein relate to PCA, other decomposition analysis or inter-channel decorrelation-based methods can be used for the encoder 160 and the decoder 170.

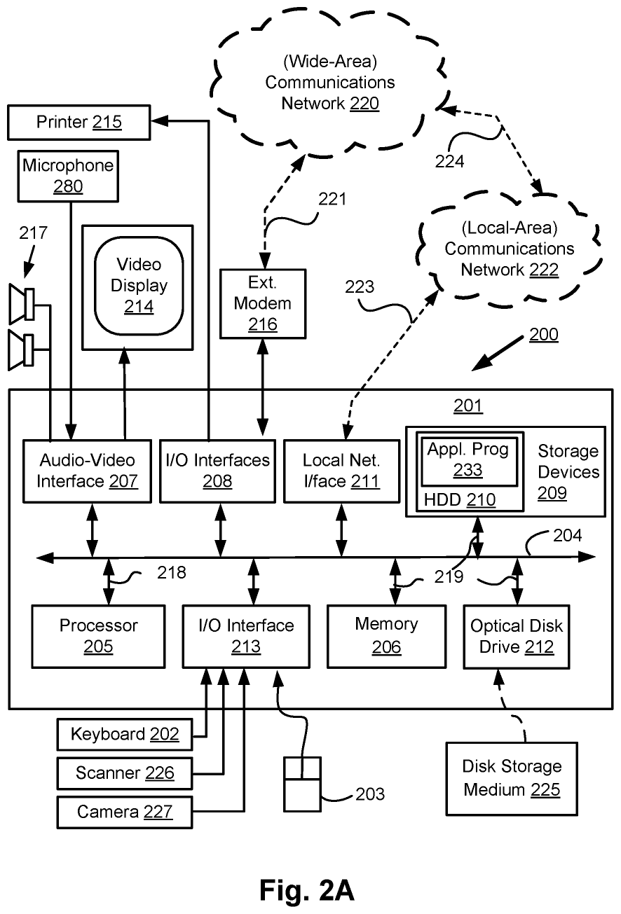

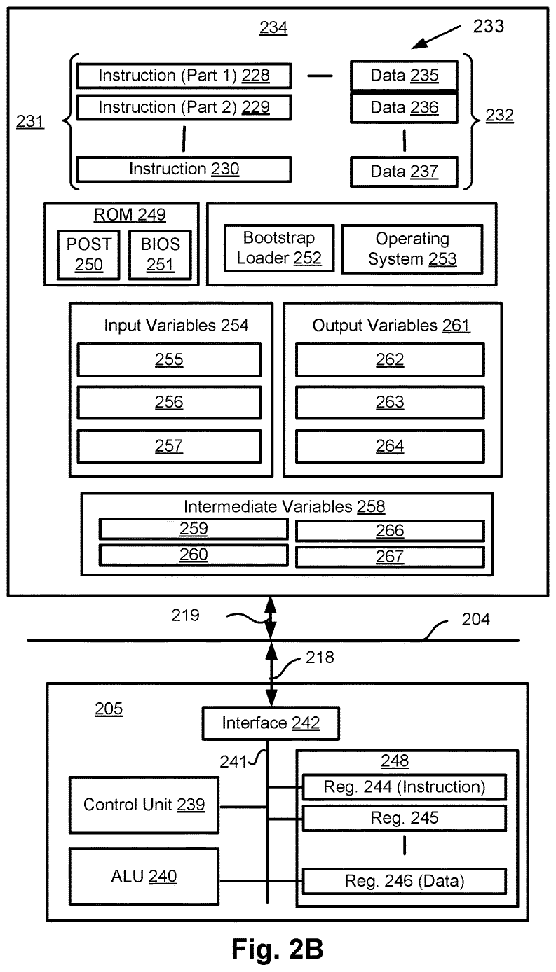

Notwithstanding the example devices mentioned above, each of the source device 110 and destination device 140 may be configured within a general-purpose computing system, typically through a combination of hardware and software components. FIG. 2A illustrates such a computer system 200, which includes: a computer module 201; input devices such as a keyboard 202, a mouse pointer device 203, a scanner 226, a camera 227, which may be configured as the video source 112, and a microphone 280; and output devices including a printer 215, a display device 214 and loudspeakers 217. An external Modulator-Demodulator (Modem) transceiver device 216 may be used by the computer module 201 for communicating to and from a communications network 220 via a connection 221. The communications network 220, which may represent the communication channel 130, may be a (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable or optical) connection, the modem 216 may be a broadband modem. A wireless modem may also be used for wireless connection to the communications network 220. The transceiver device 216 may provide the functionality of the transmitter 122 and the receiver 142 and the communication channel 130 may be embodied in the connection 221.

The computer module 201 typically includes at least one processor unit 205, and a memory unit 206. For example, the memory unit 206 may have semiconductor random access memory (RAM) and semiconductor read only memory (ROM). The computer module 201 also includes a number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The local network interface 211 may also provide the functionality of the transmitter 122 and the receiver 142 and communication channel 130 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g. CD-ROM, DVD, Blu ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as the video source 112, or as a destination for decoded video data to be stored for reproduction via the display 214. The source device 110 and the destination device 140 of the system 100 may be embodied in the computer system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

Where appropriate or desired, the PCA encoder 160 and the PCA decoder 170, as well as methods described below, may be implemented using the computer system 200. In particular, the PCA encoder 160, the PCA decoder 170 and methods to be described, may be implemented as one or more software application programs 233 executable within the computer system 200. In particular, the PCA encoder 160, the PCA decoder 170 and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the source device 110 and the destination device 140 and the described methods.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels, as well as a network connection to another computer or networked device, and the Internet or Intranets including e-mail transmissions and information recorded on Websites and the like.

The second part of the application program 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the storage devices 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A need to be used properly so that each process can run effectively. Accordingly, the aggregated memory 234 is not intended to illustrate how particular segments of memory are allocated (unless otherwise stated), but rather to provide a general view of the memory accessible by the computer system 200 and how such memory is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using the connection 218. The memory 234 is coupled to the bus 204 using the connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The PCA encoder 160, the PCA decoder 170 and the described methods may use input variables 254, which are stored in the memory 234 in corresponding memory locations 255, 256, 257. The PCA encoder 160, the PCA decoder 170 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:
a fetch operation, which fetches or reads an instruction 231 from a memory location 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

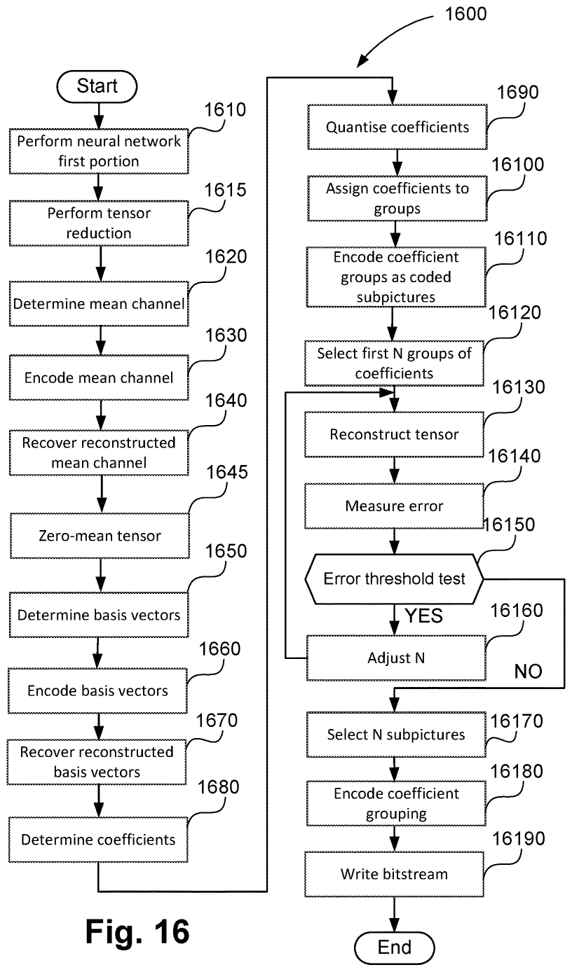

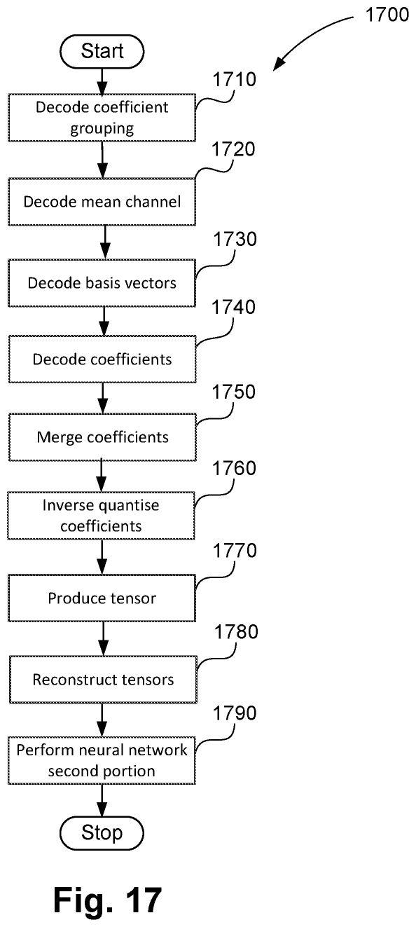

Each step or sub-process in the methods of FIGS. 16 and 17, to be described, is associated with one or more segments of the program 233 and is typically performed by the register section 244, 245, 246, the ALU 240, and the control unit 239 in the processor 205 working together to perform the fetch, decode, and execute cycles for every instruction in the instruction set for the noted segments of the program 233.

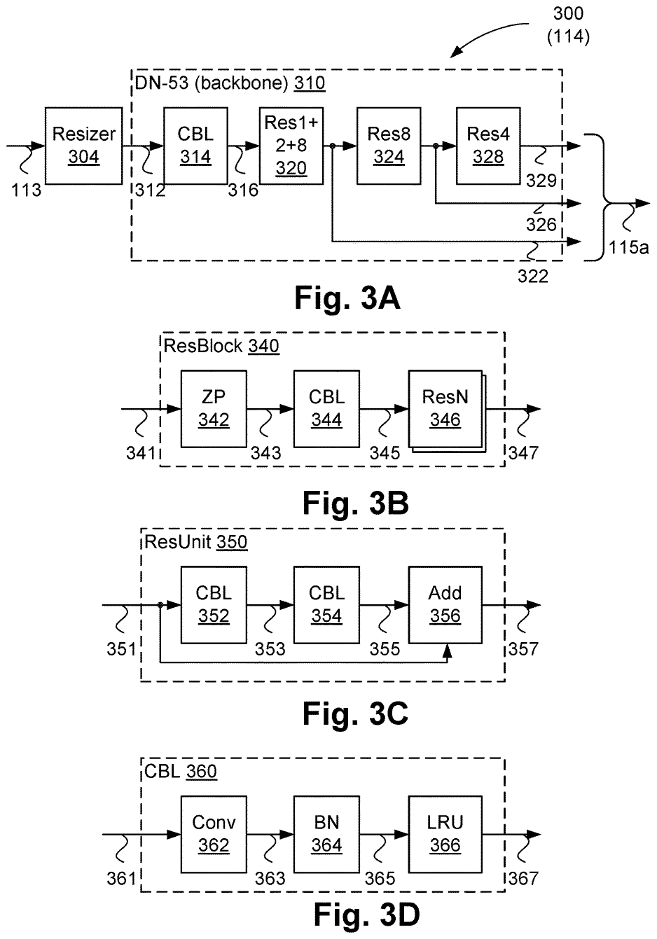

FIG. 3A is a schematic block diagram 300 showing functional modules of a backbone portion 310 of a CNN, which may serve as an implementation of the CNN backbone 114. The backbone portion 114 is sometimes referred to as ‘DarkNet-53’, although different backbones are also possible, resulting in a different number of and dimensionality of layers of the tensors 115 for each frame.

As shown in FIG. 3A, the video data 113 is passed to a resizer module 304. The resizer module 304 resizes each frame of the video data 113 to a resolution suitable for processing by the CNN backbone 310, producing a resized frame data 312. If the resolution of the video data 113 is already suitable for the CNN backbone 310, operation of the resizer module 304 is not needed. The resized frame data 312 is passed to a convolutional batch normalisation leaky rectified linear (CBL) module 314 to produce tensors 316. The CBL 314 contains modules as described with reference to a CBL module 360 as shown in FIG. 3D.

The CBL module 360 takes as input a tensor 361 of the resized frame data 312. The tensor 361 is passed to a convolutional layer 362 to produce tensor 363. If the convolutional layer 362 has a stride of one, the tensor 363 has the same spatial dimensions as the tensor 361. If the convolution layer 362 has a larger stride, such as two, the tensor 363 has smaller spatial dimensions compared to the tensor 361, for example, halved in width and height for the stride of two. Regardless of the stride, the size of channel dimension of the tensor 363 may vary compared to the channel dimension of the tensor 361 for a particular CBL block. The tensor 363 is passed to a batch normalisation module 364, which outputs a tensor 365. The batch normalisation module 364 normalises the input tensor 363 and applies a scaling factor and an offset value to produce the output tensor 365. The scaling factor and offset value are derived from a training process. The tensor 365 is passed to a leaky rectified linear activation (“LeakyReLU”) module 366 to produce a tensor 367. The module 366 provides a ‘leaky’ activation function whereby positive values in the tensor are passed through and negative values are severely reduced in magnitude, for example, to 0.1× their former value.

Returning to FIG. 3A, the tensor 316 is passed from the CBL block 314 to a residual block module 320, such as a 1+2+8 module (also referred to as an 11 module) containing a concatenation of 1 residual unit, 2 residual units, and 8 residual units internally.

A residual block is described with reference to a ResBlock 340 as shown in FIG. 3B. The ResBlock 340 receives a tensor 341. The tensor 341 is zero-padded by a zero-padding module 342 to produce a tensor 343. The tensor 343 is passed to a CBL module 344 to produce a tensor 345. The tensor 345 is passed to a residual unit 346. The residual unit 346 contains a series of concatenated residual units, based on the number of residual block (for example 11 units for the block 320). The last residual unit of the residual units 346 outputs a tensor 347.

A residual unit is described with reference to a ResUnit 350 as shown in FIG. 3C. The ResUnit 350 takes a tensor 351 as input. The tensor 351 is passed to a CBL module 352 to produce a tensor 353. The tensor 353 is passed to a second CBL unit 354 to produce a tensor 355. An add module 356 sums the tensor 355 with the tensor 351 to produce a tensor 357. The add module 356 may also be referred to as a ‘shortcut’ as the input tensor 351 substantially influences the output tensor 357. For an untrained network, ResUnit 350 acts to pass-through tensors. As training is performed, the CBL modules 352 and 354 act to deviate the tensor 357 away from the tensor 351 in accordance with training data and ground truth data.

Returning to FIG. 3A, the Res11 module 320 outputs a tensor 322. The tensor 322 is output from the backbone module 310 as one of the layers and also provided to a Res8 module 324. The Res8 module 324 is a residual block (i.e., 340), which includes eight residual units (i.e. 350). The Res8 module 324 produces a tensor 326. The tensor 326 is passed to a Res4 module 328 and output from the backbone module 310 as one of the layers. The Res4 module is a residual block (i.e., 340), which includes four residual units (i.e., 350). The Res4 module 328 produces a tensor 329. The tensor 329 is output from the backbone module 310 as one of the layers. Collectively, the layer tensors 322, 326, and 329 are output as the tensors 115a. The backbone CNN 310 may take as input a video frame of resolution 1088×608 and produce three tensors, corresponding to three layers, with the following dimensions: [1, 256, 76, 136], [1, 512, 38, 68], [1, 1024, 19, 34]. Another example of the three tensors 115 corresponding to three layers may be [1, 512, 34, 19], [1, 256, 68, 38], [1, 128, 136, 76] which are respectively separated at 75th feature map, 90th feature map, and 105th feature map in the CNN 310. The separating points depend on the CNN 310.

Each of the Res11 320, Res8 324 and Res4 328 operates in a similar manner to ResBlock 340. Each of the CBL 314, the CBL 344 and the CBL 354 operate in a similar manner to the CBL 360.

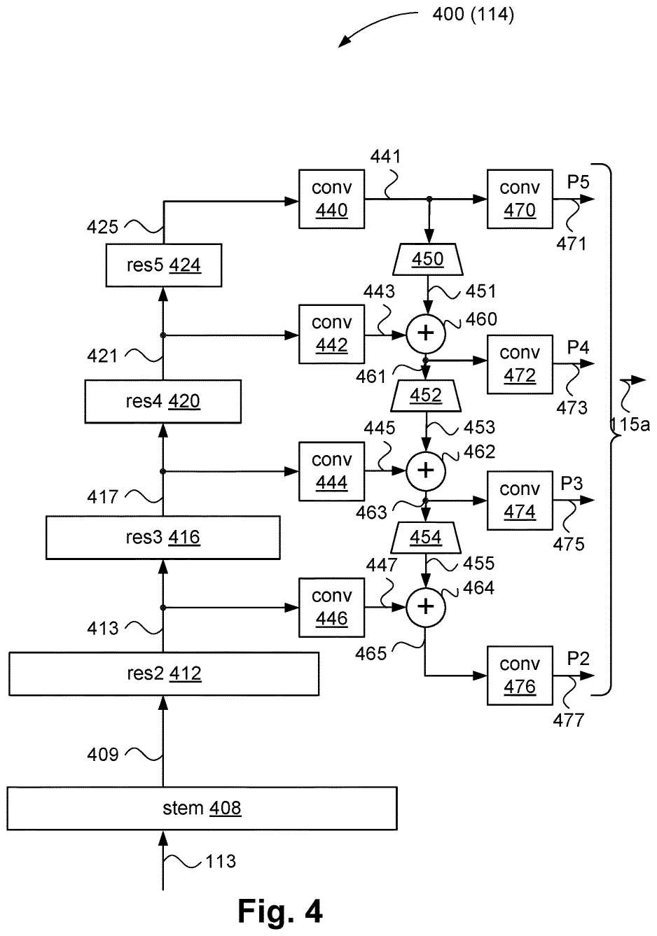

FIG. 4 is a schematic block diagram showing functional modules of an alternative backbone portion 400 of a CNN, which may serve as an implementation of the CNN backbone 114. The backbone portion 400 implements a residual network with feature pyramid network (‘ResNet FPN’) and is used in networks such as FasterRCNN and MaskRCNN. Frame data 113 is input and passes through a stem network 408, a res2 module 412, a res3 module 416, a res4 module 420, and a res5 module 424 via tensors 409, 413, 417, 421, 425 respectively.

The stem network 408 includes a 7×7 convolution with a stride of two (2) and a max pooling operation. The res2 module 412, the res3 module 416, the res4 module 420 and the res5 module 424 perform convolution operations, such as LeakyReLU activations. Each module 412, 416, 420 and 424 also performs one halving of the width and height of the processed tensors via a stride setting of two. Each of the tensors 413, 417, 421 and 425 are passed to one of 1×1 lateral convolution modules 446, 444, 442 and 440 respectively. The modules 446, 444, 442, and 440 produce tensors 447, 445, 443 and 441 respectively. The tensor 441 is passed to a 3×3 output convolution module 470, which produces an output tensor P5 471.

The tensor 441 is also passed to upsampler module 450 to produce an upsampled tensor 451. A summation module 460 sums the tensors 443 and 451 to produce a tensor 461. The tensor 461 is passed to an upsampler module 452 and a 3×3 lateral convolution module 472. The module 472 outputs a P4 tensor 473. The upsampler module 452 produces an upsampled tensor 453. A summation module 462 sums tensors 445 and 453 to produce a tensor 463. The tensor 463 is passed to a 3×3 lateral convolution module 474 and an upsampler module 454. The module 474 outputs a P3 tensor 475. The upsampler module 454 outputs an upsampled tensor 455. A summation module 464 sums the tensors 447 and 455 to produce tensor 465, which is passed to a 3×3 lateral convolution module 476. The module 476 outputs a P2 tensor 477. The upsampler modules 450, 452, and 454 use nearest neighbour interpolation for low computational complexity. The tensors 429, 471, 473, 475, and 477 form the output tensor 115a of the CNN backbone 400. Although FIG. 4 shows a particular backbone portion of the Faster RCNN network architecture (a ‘P-layer split point), different divisions into backbone and head are possible. Splitting the network at tensor 409 is termed a ‘stem’ split point. Splitting the network at tensors 447, 445, 443, and 441 is termed a ‘C-layer’ split point.

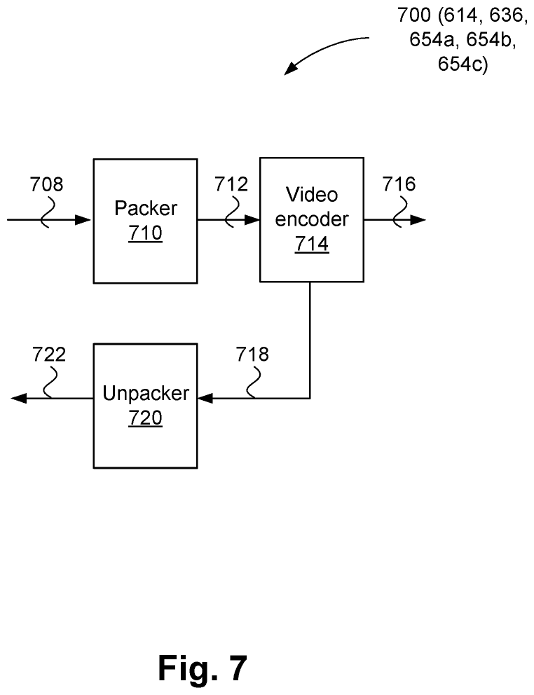

FIG. 5 is a schematic block diagram 500 showing one type of multi-scale feature fusion module 500, which may serve as the tensor combiner 162. FIG. 6 is a schematic block diagram 600 showing an inter-channel decorrelation-based tensor encoder. FIG. 7 is a schematic block diagram 700 showing a subpicture encoder. The encoders 600 and 700 form the PCA encoder 160 of the system 100. FIGS. 5-7 are described with reference to FIG. 16.

FIG. 16 shows a method 1600 for performing a first portion of a CNN and encoding the resulting feature maps for a frame of video data. In encoding the feature maps, tensors are encoded into the bitstream. The method 1600 may be implemented using apparatus such as a configured FPGA, an ASIC, or an ASSP. Alternatively, as described below, the method 1600 may be implemented by the source device 110, as one or more software code modules of the application programs 233, under execution of the processor 205. The software code modules of the application programs 233 implementing the method 1600 may be resident, for example, in the hard disk drive 210 and/or the memory 206. The method 1600 is performed for each frame of video data produced by the video source 112. The method 1600 may be stored on computer-readable storage medium and/or in the memory 206. The method 1600 begins at a perform CNN first portion step 1610.

At the step 1610, the CNN backbone 114, under execution of the processor 205, performs a subset of the layers of a particular CNN to convert an input frame 113 into intermediate tensors 115a. The intermediate tensors 115a may be stored, for example, in the memory 206 and/or hard disk drive 210. An example CNN being ‘Faster R-CNN’ or ‘Mask R-CNN’ and the subset of layers corresponding to all layers up to a ‘P-layer’ split point, as shown in FIG. 4. When multiple tensors are extracted from the CNN backbone 114, e.g., due to use of a FPN, the tensors 115a contain one tensor for each FPN layer. Control in the processor 205 progresses from the step 1610 to a perform tensor reduction step 1615.

At the step 1615 the tensor combiner 162 operates under execution of the processor 205 to resample individual tensors among the tensors 115a producing one combined tensor 115 as output. The multi-scale feature fusion (MSFF) module 500 includes an MSFF block 510 shown in FIG. 5, which produces a single tensor from the plurality of tensors 115a using one or more downsampling filters. The MSFF block 510, under execution of the processor 205, combines each tensor of a first set of tensors, i.e., 502, 503, 504, 505, to produce the combined tensor 115a. The combined tensor 115a forms a representation of the FPN layer tensors. Downsample modules 522a, 522b, and 522c operate on the tensors having larger spatial scale, i.e., P4 504 at 2 h, 2w, 256, and P3 503 at 4 h, 4w, 256, and P2 502 at 8 h, 8w, 256, respectively. Modules 522a, 522b, and 522c perform downsampling to match the spatial scale of the smallest tensor, i.e., P5 505 at h, w, 256, producing downscaled P5 tensors 523a, 523b, 523c, respectively. A concatenation module 524 performs a channel-wise concatenation of the tensors 505, 523a, 523b, and 523c to produce concatenated tensor 525, of dimensions h, w, 1024. The concatenated tensor 525 is passed to a squeeze and excitation (SE) module 526 to produce a tensor 527. The SE module 526 sequentially performs a global pooling, a fully-connected layer with reduction in channel count, a rectified linear unit activation unit, a second fully-connected layer restoring the channel count, and a sigmoid activation function to produce a scaling tensor. The tensor 525 is scaled according to the scaling tensor to produce the output as the tensor 527. The SE block 526 is capable of being trained to adaptively alter the weighting of different channels in the tensor passed through, based on the first fully-connected layer output. The first fully-connected layer output reduces each feature map for each channel to a single value. Each single value is passed through the non-linear activation unit (ReLU) to create a conditional representation of the unit, suitable for weighting of other channels, with restoration to the full channel count performed by the second fully-connected layer. The SE block 526 is thus capable of extracting non-linear inter-channel correlation in producing the tensor 527 from the tensor 525, to a greater extent than is possible purely with convolutional (linear) layers. The tensor 527 is passed to a convolutional layer 528. The convolutional layer 528 implements one or more convolutional layers to produce the combined tensor 115, with channel count reduced to F channels, typically 256 channels (i.e., F=256). Control in the processor 205 progresses from the step 1615 to a determine mean channel step 1620.

In alternative implementations, the convolutional layer 528 can be omitted from the module 500, as shown in dashed lines. In implementations omitting the convolutional layer 528, the tensor 527 is output as the tensor 115. Effectively, in implementations excluding 528, the tensor 115 is produced using the output of an addition of tensors including the result of an activation layer in the SE block 526. The number of channels at the tensor 115 is not reduced to F channels if the layer 528 is omitted. With P2-P5 layers each having 256 channels, the channel count at the tensor 115 when the convolutional layer 528 is omitted will be 1024. Applying a convolutional layer 528 to the scaled tensor 527, as described above, reduces the channel count and hence the dimensionality of the tensor data supplied to the PCA encoder 160 and recovered by the PCA decoder 170.

At the determine mean channel step 1620, the tensor 115 is averaged. Referring to FIG. 6, a module 610, under execution of the processor 205, performs an average operation on the tensor 115 across the spatial dimensions to produce a per-channel mean 611. The mean channel 611 is quantised by a quantiser 612 under execution of the processor 205 to produce an integer (quantised) mean channel list 613 at step 1620, along with a quantisation range indicating the floating-point range required to hold the mean channel 611. Control in the processor 205 progresses from the step 1620 to an encode mean channel step 1630.

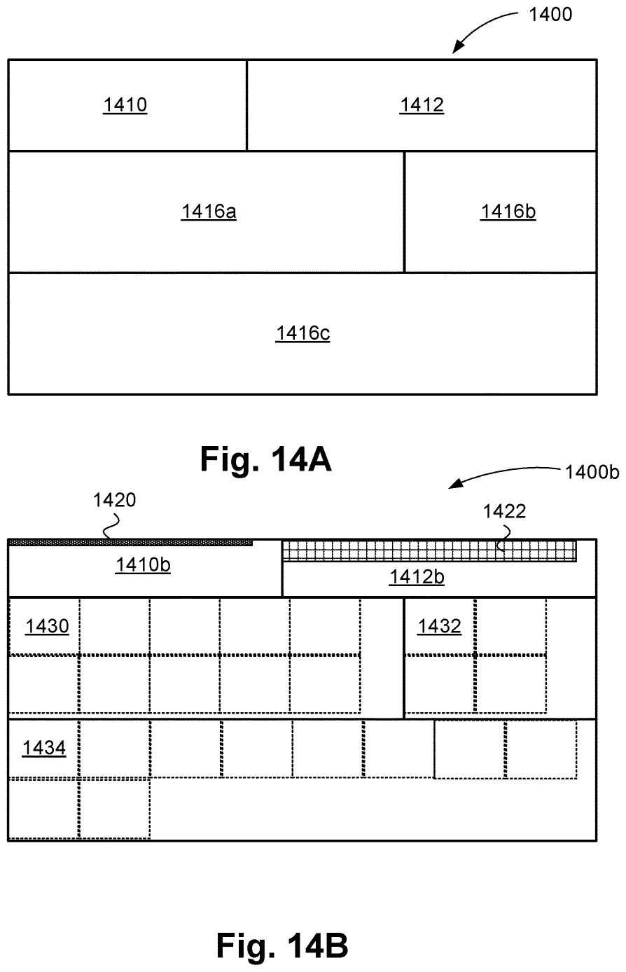

At the encode mean channel step 1630, a subpicture encoder 614, under execution of the processor 205, packs the integer mean channel 613 into a subpicture (for example as a subpicture 1410 shown in FIG. 14) and encodes the subpicture to produce bitstream portion 615 using the subpicture encoder 614. Since the mean channel 613 contains one value per channel, the channel 613 may be treated as a feature map of, e.g., height 1 and width 256 when representing the mean of a tensor with 256 channels.

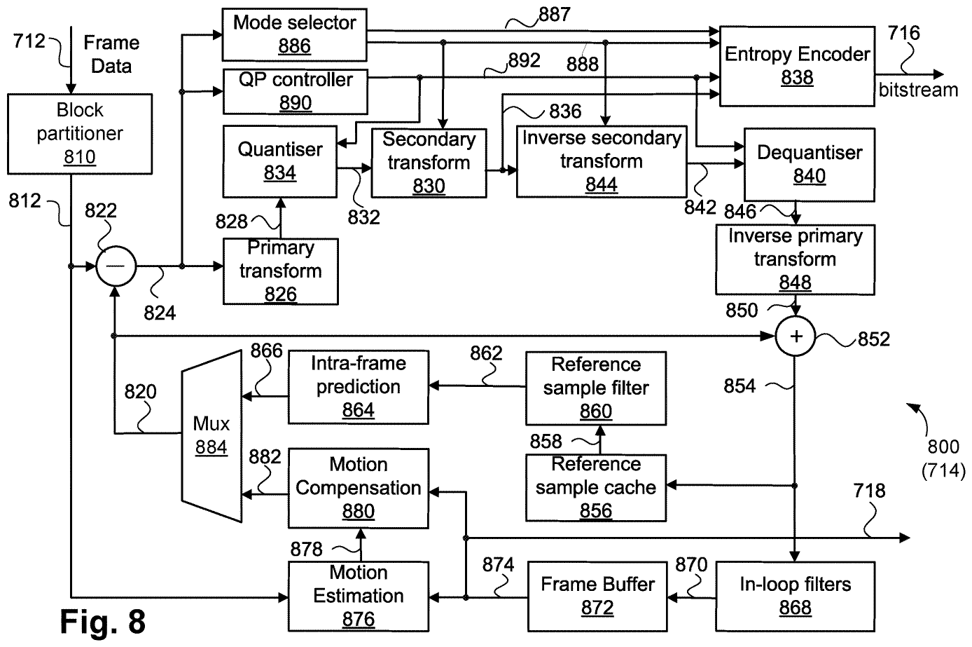

The subpicture encoder 614 implements the architecture 700. The architecture 700 includes a feature map packer 710, a video frame encoder 714, and an unpacker 720. Subpicture encoders 614, 636, 654a, 654b, and 654c are implemented as instances of the architecture 700. The packer 710 receives a tensor 708 having a given channel count, width and height dimensions and containing integer values, i.e., already quantised. For example, the subpicture encoder 614 receives the integer mean channel 613. The packer 710 packs the received tensor into a 2D planar array of samples. Generally, in the arrangements described feature maps of the respective channels of the tensor 708 are stored as a subpicture frame 712, in a left-to-right and top-to-bottom manner. The subpicture frame 712 needs to be of sufficient size to hold the channels of the tensor 708, including allowance for gaps in packing due to mismatch between feature map size and subpicture frame 712 dimensions. Operation of the video frame encoder 714, generally implemented as a VVC encoder, is described with reference to FIG. 8. The encoder 714 produces an encoded bitstream portion 716, corresponding to a respective subpicture. For example, the subpicture encoder 614 outputs an encoded bitstream portion 615. The encoder 714 also outputs a reconstructed frame 718, corresponding to a lossy version reproduced when decoding the bitstream portion 716. The reconstructed frame 718 represents a reconstruction of the mean channel 613, in which losses invoked due to encoding are modelled or represented. The losses reflect encoding losses such as those incurred by the particular encoding method used at the encoder 714. In the example described in FIGS. 7 and 8, the encoder 714 is a VVC encoder. The reconstructed frame 718 is passed to the unpacker 720. The unpacker 720 extracts feature maps to produce a reconstructed tensor 722 having the same dimensionality as the tensor 708, forming the tensor by performing a channel-wise concatenation of the unpacked feature maps.

As a result of operation of the module 700, the PCA encoder 160 is able to use versions of feature maps (or coefficients) that correspond to the versions seen in the PCA decoder 170. The PCA encoder 160 can accordingly operate at a higher level of fidelity than if the effect of lossy coding were not taken into account. Subpicture encoders 614, 636, 654a, 654b, and 654c are configured to disable loop filtering both internally and across subpicture boundaries, as loop filtering is generally optimised for human consumption of decoded pictures. Furthermore, motion compensation is prohibited to access samples across subpicture boundaries via an activated ‘sps_subpic_treated_as_pic_flag’ flag for each subpicture. The system 100 uses video compression to relatively efficiently represent data resulting from the dimensional reduction performed on the intermediate tensor data that needs to be propagated from the CNN backbone 114 to the CNN head 150.

Returning to FIG. 16, control in the processor 205 progresses from the step 1630 to a recover reconstructed mean channel step 1640.

At the recover reconstructed mean channel step 1640 the subpicture encoder 614, under execution of the processor 205, outputs a reconstructed picture, e.g., 716, within an implementation of the encoder 700, corresponding to a lossy version of the subpicture input for video compression, e.g., 712. The reconstructed picture is unpacked and output as integer tensor 616. Control in the processor 205 progresses from the step 1640 to a zero-mean tensor step 1645.

At the step 1645 an inverse quantiser module 620 and a subtraction module 622, under execution of the processor 205, produce a zero-mean tensor 623. The inverse quantiser 620 takes the integer tensor 616 and outputs a reconstructed mean channel 621 using the quantisation range as determined in the quantiser module 612. The mean reconstructed channel 621 is a list of values, one value per channel in the tensor 115, corresponding to the detected DC offset in the respective channel. For each channel in the combined tensor 115, a DC shift is performed by subtracted a value, constant for the feature map, from each spatial location in the feature map. The subtracted value is a respective value in the mean reconstructed channel 621. As a result of the subtraction module 622, a zero-centred tensor 623 is output with DC component found within each feature map removed from the respective feature map. Control in the processor 205 progresses from the step 1645 to a determine basis vectors step 1650.

At the determine basis vectors step 1650, a decomposition module 630, under execution of the processor 205, operates to produce a set of basis vectors for the combined tensor 115. The decomposition module 630 receives the zero-centred tensor 623 as an input and generates a set of basis vectors 631 by performing a principal component analysis method, such as singular value decomposition (SVD) or the like. One basis vector maps all channels onto a single value, so with 256 channels in the tensor 115, one basis vector has dimensions 256×1. If the decomposition module produces the first N basis vectors, such as 25, the result basis vectors have dimensions 256×N or 256×25. Basis vectors are relative to the origin point and so the zero-mean tensor 623 needs to be used to ensure an orthonormal basis can be found. Each basis vector is a vector relating all the channels to a reduced set of channels. As such, the basis vectors collectively enable representing tensor data spanning all channels into a smaller set of basis vectors. Each basis vector is derived with all samples in each feature map for a given channel being considered. The vectors 631 contain fewer basis vectors than there are channels in the tensor 115, corresponding to a reduction in the dimensionality of the tensor 115. The basis vectors in 631 represent the tensor 115 in a subspace that accounts for, or ‘explains’, the maximum amount of variance in the tensor 115 for the number of components in the basis vectors 631. Basis vectors are ordered from the vector with the greatest explained variance down to the vector with the least explained variance. In other words, the basis vectors 631 enable representation of the tensor 115 with minimal degradation in quality for a given number of components, with the components being the first N ranked basis vectors. Control in the processor 205 progresses from the step 1465 to an encode basis vectors step 1660.

At the encode basis vectors step 1660, a quantiser module 632, under execution of the processor 205, operates to quantise the basis vectors 631 into the integer domain. The resultant integers basis vectors 634 are and packed into a subpicture and encoded to produce bitstream portion 637 by the subpicture encoder 636 under execution of the processor 205. Control in the processor 205 progresses from the step 1660 to a recover reconstructed basis vectors step 1670.

At the step 1670, the subpicture encoder 636 generates the reconstructed integer tensor 638, under execution of the processor 205, and operates to obtain a reconstructed version of the subpicture 1412, e.g., 638. The basis vectors 638 are unpacked from the reconstructed subpicture and inverse quantised back into the floating-point domain (as the reconstructed basis vectors 640) by the inverse quantiser 660 under execution of the processor 205. Control in the processor 205 progresses from the step 1670 to a determine coefficients step 1680.

At the step 1680, a dot product module 642, under execution of the processor 205, performs a dot product of each channel in the tensor 623 against each vector in the reconstructed basis vectors 640 to produce coefficients tensor 644. The coefficients form a tensor having the same width and height as the tensor 115 but a channel count corresponding to the number of components (or basis vectors) produced by the decomposition module 630, which is fewer than the number of channels in the tensor 115. The coefficients tensor 644 represents the contribution of each basis vector in reproducing each value in each feature map. Control in the processor 205 progresses from the step 1680 to a quantise coefficients step 1690.

At the step 1690, a quantiser module 646, under execution of the processor 205, quantises the coefficients tensor 644 to produce integer coefficients 648, a tensor having the same dimensionality as the coefficients tensor 644, that is, having c channels, w width and h height, where c corresponds to the number of basis vectors. A quantisation range is determined from extrema among the coefficients tensor 644. Control in the processor 205 progresses from the step 1690 to an assign coefficients to groups step 16100.

In executing either of steps 1680 and 1690, the method 1600 operates to produce coefficients for a tensor using the (reduced) tensor generated at step 1615 and the set of basis vectors. The tensor for which the coefficients are produced has the same spatial size and fewer channels than the tensor generated at step 1615.

At the step 16100 a group module 650, under execution of the processor 205, determines a set of groups for the coefficients tensor 644. Each group contains coefficients for whole feature maps and one or more channels, contiguous along the channel dimension. The first group always contains coefficients using the first basis vector. In other words, the coefficients tensor 644 is sliced along the channel dimension to form a set of groups of coefficients 652, overall having c channels, w width and h height. Each group includes a contiguous range of channels and the groups are adjacent. Collectively, the groups include all channels. In the context of the coefficients tensor 644, the channel dimension corresponds to the number of basis vectors rather than the channel count of the combined tensor 115. The boundaries between groups are established when encoding the first frame of the video data, which corresponds to establishing the subpicture layout in a sequence parameter set (SPS) associated with an instantaneous decoder refresh (IDR) picture in the bitstream 121. Each group may be encoded as a unit of coefficient information to be included or omitted from the bitstream 121. As such, the inclusion of omission of groups of coefficients forms a means for rate control or quality scalability for the system 100. The use of larger groups incurs less coding overhead due to using fewer subpictures, but at the expense of coarser granularity of rate control. The group containing coefficients for the first basis vector, i.e., the basis vector with the maximum amount of explained variance, may be relatively large and always coded, providing a fixed, minimum quality level. The boundaries between slices whose corresponding basis vectors correspond to lesser amounts of explained variance may be set closer together, resulting in smaller groups and hence more groups required until all coefficients for all basis vectors are encodable in the bitstream 121. Regardless of the number of groups, the total quantity of coefficients is unchanged as this is set by the number of basis vectors and the feature map size within the combined tensor 115. Aside from gaps resulting in packing coefficients in each group into separate subpictures (as described hereafter in relation to FIGS. 14A and 14B), the coded area for the resulting packed frame data is not substantially affected by the division of coefficients into groups. Generally, the first group contains relatively many coefficients as necessary to provide a minimum fidelity for reconstructed tensors that gives a suitable level of performance. Then, subsequent subpictures are small in size giving few coefficients per subpicture and hence a fine granularity of rate control. The final subpicture is larger in size due to the needs to occupy remaining area in the rectangular picture 1400.

Effectively, the step 1650 operates to produce coefficients for a tensor using a plurality of basis vectors, the coefficients forming one feature map for each basis vector of the plurality of basis vectors. In determining the set of groups, the step 16100 operates to produce an assignment that groups coefficients according to the respective basis vector. As described hereafter, the assignment may be adjusted. The assignment may be based, at least in part, on the fidelity of the reconstructed tensor, i.e., using the coefficients 670. The coefficients 670 are based on the reconstructed feature frame produced in the video encoders 614, 636, 654a, 654b and 654c. Here, ‘reconstructed’ indicates the feature frame includes artefacts resulting from quantisation and forward transform stages. As entropy encoding is lossless, it is not necessary to produce the coefficients 670 by entropy decoding the bitstream 121. Control in the processor 205 progresses from the step 16100 to an encode coefficient groups as subpictures step 16110.

At the step 16110 each group of the resulting grouped coefficients 652 are provided to a subpicture encoder (e.g., a respective one of encoders 654a, 654b, and 654c) such that each group is processed by a separate subpicture encoder, with sufficient instances of subpicture encoders for the division of the coefficients 648 into groups 652. Each subpicture encoder produces a bitstream portion, resulting in a set of bitstream portions 656. The encoder 600 is required to select which bitstream portions within the portions 656 to include in the bitstream 121. The selection can be based on testing the fidelity of a reconstructed tensor with varying numbers of bitstream portions or groups, as described in the remaining steps of the method 1600. Control in the processor 205 progresses from the step select first N groups of coefficients step 16120.

At the step 16120 the processor 205 selects the first N groups among the groups 652, such that the group with the basis vector having greatest explained variance is included and the groups form a contiguous set of groups when grouped based on basis vector (and hence explained variance) order. Initially, the value N may be set as one, i.e., selecting the first group. Alternatively, the value N may be set to the value is finally selected when processing the previous frame in a previous invocation of the method 1600. Control in the processor 205 progresses from the step 16120 to a reconstruct tensor step 16130.

At the step 16130 a merge groups module 664, an inverse quantiser module 668, and a dot product module 672, under execution of the processor 205, operate to produce a reconstructed tensor 674. The reconstructed tensor 674 is a version of the tensor 637 that takes into account losses resulting from quantisation from floating-point domain to integer sample domain (i.e., from modules 612, 632, and 646), losses from forward transform modules 826 and 830 in the video encoder 800 and sample-domain quantisation from the quantiser module 834. As operation of the entropy encoder 838 is lossless, no further discrepancy exists between the reconstructed tensor 674 and a tensor 942 derived in the PCA decoder 170. The reconstructed tensor 674 is produced using reconstructed coefficients 662 for the groups of coefficients as selected at the step 16120. The reconstructed tensor 674 may be referred to as a ‘projection’ of the basis vectors with the coefficients as the tensor 674 occupies a higher-dimensionality subspace than the subspace occupied by the coefficients. The merge groups module 664 merges each group of coefficients, resulting in the production of a single tensor of coefficients. In other words, the merge groups module 664 performs a concatenation of the groups of coefficients along the channel dimension, which in the transformed domain corresponds to basis vectors, to produce reconstructed integer coefficients 666. The reconstructed coefficients 666 are inverse quantised from the integer domain to the floating-point domain using quantisation ranges as determined by the quantiser module 646 to produce reconstructed coefficients 670. The dot product module 672 is used to produce a reconstructed tensor 674 by performing a dot product operation on the reconstructed coefficients 670 and the reconstructed basis vectors 640. The result of the dot product module 672 is additive between the groups of coefficients. When adding one group of coefficients, a delta for the reconstructed tensor 674 may be produced by performing the dot product 672 just using coefficients and basis vectors in the additional group, and the delta added to the previously determined reconstructed tensor 674 to produce an updated reconstructed tensor 674. Control in the processor 205 progresses from the step 16130 to a measure error step 16140.

At the step 16140 a mean-squared error (MSE) module 676 produces a MSE result taking the zero-centred tensor 623 and the reconstructed tensor 674 as input. The MSE result provides an indication of the fidelity of the reconstructed tensor 674. Higher fidelity of the reconstructed tensor 674 makes the loss introduced by feature compression in the system 100 lower relative to the performance achieved by the network embodied in the system 100 being performed without splitting into portions but requires coding more bitstream portions and hence requires a higher bandwidth in the communications channel 130. Control in the processor 205 progresses from the step 16140 to an error threshold test step 16150.

At the step 16150 processor 205 compares the MSE result from the step 16140 with a threshold value. The threshold value may be a predetermined value or may be a running average of previously encountered MSE results. If the MSE result is below the threshold value and the number of currently selected groups is less than all available groups, the step 1650 returns “YES” and control in the processor 205 progresses from the step 16150 to an adjust N step 16160. Otherwise, the step 1650 returns “NO” and control in the processor 205 progresses from the step 16150 to a select N subpictures step 16170.

The steps 16130 to 16150 operate to encode and decode the coefficients such that each group of coefficients is encoded and decoded independently. The encoding and decoding are used at step 16150 to determine if the assignment determined at step 16100 is to be adjusted. As described in relation to modules 646 to 668, the assignment or grouping of the coefficients may be based on a distance metric (delta), such as sum of absolute differences (SAD) or mean squared error (MSE), between the tensor 623 and the tensor 674 resulting from the dot product operation on the decoded or reconstructed coefficients.

At the step 16160 the number of selected groups is increased by one, so that one additional group, being the next group containing coefficients with greater explained variance among the currently unselected groups, is selected. Accordingly, steps 16100 to 16160 can be considered to firstly produce an assignment that groups coefficients according to the respective basis vector and then to select which subset of the groups of encoded coefficients are to be included in the bitstream 121. Control in the processor 205 progresses from the step 16160 to the step 16130.

At the step 16170, bitstream portions among the bitstream portions 656 are selected by a gate module 658 so that only bitstream portions corresponding to subpictures for the first N groups as determined at the step 16120 are selected. The selected bitstream portions are propagated by the gate module 658 to form selected bitstream portions 660. For subpictures that are not selected, either a ‘gap’ or uncoded region in the picture 1400 may result, or the subpicture may be replaced with a bitstream portion with contents that are compactly represented and consumes negligible bitrate, such as a DC mid-tone value. Control in the processor 205 progresses from the step 16170 to an encode coefficient grouping step 16180.

At the step 16180 the processor 205 encodes signalling into the bitstream indicative of coefficient grouping and coding. In other words, the coefficients of each tensor are encoded into the bitstream for each frame. When encoding an IDR picture, signalling is coded indicating the division of coefficients into groups. For all frames, signalling is coded indicating which groups are present in the bitstream 121. For example, a value N indicating usage of the first N groups is coded into the bitstream, or a bitmap indicating usage of specific groups is coded into the bitstream.

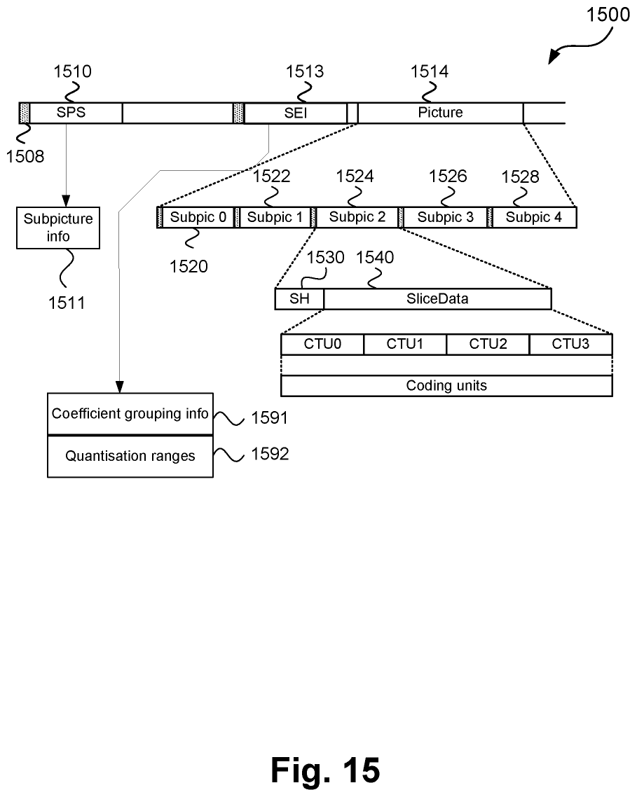

The step 16170 operates to encode the subpicture arrangement described by the assignment produced by steps 16100 to 16160, whereas step 16180 operates to encode the assignment to the bitstream. As described in relation to FIG. 15, a new subpicture structure is commenced when a change in the assignment has been determined. Control in the processor 205 progresses from the step 16180 to a write bitstream step 16190.

At the step 16190, a subpicture bitstream combiner 680 combines bitstream portions 615, 637, and 660 to produce (or ‘write’) a single bitstream 121. Upon completion of the step 16190 the method 1600 terminates for the current frame 113 from the video source 112.

FIG. 8 is a schematic block diagram 800 showing functional modules of the video encoder 714. The video encoder 714 encodes one subpicture amongst a set of subpictures comprising an overall picture. While it is possible for all subpictures to be encoded in one encoding pass, use of one encoding pass prevents the lossy decoded version of data within a given subpicture from being used as input when generating data to be encoded in another subpicture and hence the PCA encoder 160 is unable to account for lossy coding in the pipeline. Generally, data passes between functional modules within the video encoder 714 in groups of samples or coefficients, such as divisions of blocks into sub-blocks of a fixed size, or as arrays. The video encoder 714 may be implemented using a general-purpose computer system 200, as shown in FIGS. 2A and 2B, where the various functional modules may be implemented by dedicated hardware within the computer system 200, by software executable within the computer system 200 such as one or more software code modules of the software application program 233 resident on the hard disk drive 205 and being controlled in its execution by the processor 205. Alternatively, the video encoder 714 may be implemented by a combination of dedicated hardware and software executable within the computer system 200. The video encoder 714 and the described methods may alternatively be implemented in dedicated hardware, such as one or more integrated circuits performing the functions or sub functions of the described methods. Such dedicated hardware may include graphic processing units (GPUs), digital signal processors (DSPs), application-specific standard products (ASSPs), application-specific integrated circuits (ASICs), field programmable gate arrays (FPGAs) or one or more microprocessors and associated memories. In particular, the video encoder 714 comprises modules 810-890 which may each be implemented as one or more software code modules of the software application program 233.

Although the video encoder 714 of FIG. 7 is an example of a versatile video coding (VVC) video encoder, other video codecs may also be used to perform the processing stages described herein. For example, HEVC may be used. The examples described generate a bitstream of encoded data. If other codecs were used, some implementations may pack data into a different format such as a frame format or the like. The video encoder 714 receives subpicture frame data 712, such as a series of frames of subpictures, each frame including one or more colour channels. The frame data 712 may be in any chroma format and bit depth supported by the profile in use, for example 4:0:0, 4:2:0 for the “Main 10” profile of the VVC standard, at eight (8) to ten (10) bits in sample precision. A block partitioner 810 firstly divides the frame data 712 into CTUs, generally square in shape and configured such that a particular size for the CTUs is used. The maximum enabled size of the CTUs may be 32×32, 64×64, or 128×128 luma samples for example, configured by a ‘sps_log2_ctu_size_minus5’ syntax element present in the ‘sequence parameter set’. The CTU size also provides a maximum CU size, as a CTU with no further splitting will contain one CU. The block partitioner 810 further divides each CTU into one or more CBs according to a luma coding tree and a chroma coding tree. The luma channel may also be referred to as a primary colour channel. Each chroma channel may also be referred to as a secondary colour channel. The CBs have a variety of sizes, and may include both square and non-square aspect ratios. However, in the VVC standard, CBs, CUs, PUs, and TUs always have side lengths that are powers of two. Thus, a current CB, represented as 812, is output from the block partitioner 810, progressing in accordance with an iteration over the one or more blocks of the CTU, in accordance with the luma coding tree and the chroma coding tree of the CTU.

The CTUs resulting from the first division of the frame data 712 may be scanned in raster scan order and may be grouped into one or more ‘slices’. A slice may be an ‘intra’ (or ‘I’) slice. An intra slice (I slice) indicates that every CU in the slice is intra predicted. Generally, the first picture in a coded layer video sequence (CLVS) contains only I slices, and is referred to as an ‘intra picture’. The CLVS may contain periodic intra pictures, forming ‘random access points’ (i.e., intermediate frames in a video sequence upon which decoding can commence). Alternatively, a slice may be uni- or bi-predicted (‘P’ or ‘B’ slice, respectively), indicating additional availability of uni- and bi-prediction in the slice, respectively.

The video encoder 714 encodes sequences of pictures according to a picture structure. One picture structure is ‘low delay’, in which case pictures using inter-prediction may only reference pictures occurring previously in the sequence. Low delay enables each picture to be output as soon as it is decoded, in addition to being stored for possible reference by a subsequent picture. Another picture structure is ‘random access’, whereby the coding order of pictures differs from the display order. Random access allows inter-predicted pictures to reference other pictures that, although decoded, have not yet been output. A degree of picture buffering is needed so the reference pictures in the future in terms of display order are present in the decoded picture buffer, resulting in a latency of multiple frames.

When a chroma format other than 4:0:0 is in use, in an I slice, the coding tree of each CTU may diverge below the 64×64 level into two separate coding trees, one for luma and another for chroma. Use of separate trees allows different block structure to exist between luma and chroma within a luma 64×64 area of a CTU. For example, a large chroma CB may be collocated with numerous smaller luma CBs and vice versa. In a P or B slice, a single coding tree of a CTU defines a block structure common to luma and chroma. The resulting blocks of the single tree may be intra predicted or inter predicted.

In addition to a division of pictures into slices, pictures may also be divided into ‘tiles’. A tile is a sequence of CTUs covering a rectangular region of a picture. CTU scanning occurs in a raster-scan manner within each tile and progresses from one tile to the next. A slice can be either an integer number of tiles, or an integer number of consecutive rows of CTUs within a given tile.

For each CTU, the video encoder 714 operates in two stages. In the first stage (referred to as a ‘search’ stage), the block partitioner 810 tests various potential configurations of a coding tree. Each potential configuration of a coding tree has associated ‘candidate’ CBs. The first stage involves testing various candidate CBs to select CBs providing relatively high compression efficiency with relatively low distortion. The testing generally involves a Lagrangian optimisation whereby a candidate CB is evaluated based on a weighted combination of rate (i.e., coding cost) and distortion (i.e., error with respect to the input frame data 712). ‘Best’ candidate CBs (i.e., the CBs with the lowest evaluated rate/distortion) are selected for subsequent encoding into the bitstream portion 716. Included in evaluation of candidate CBs is an option to use a CB for a given area or to further split the area according to various splitting options and code each of the smaller resulting areas with further CBs, or split the areas even further. As a consequence, both the coding tree and the CBs themselves are selected in the search stage.

The video encoder 714 produces a prediction block (PB), indicated by an arrow 820, for each CB, for example, CB 812. The PB 820 is a prediction of the contents of the associated CB 712. A subtracter module 822 produces a difference, indicated as 824 (or ‘residual’, referring to the difference being in the spatial domain), between the PB 820 and the CB 812. The difference 824 is a block-size difference between corresponding samples in the PB 820 and the CB 812. The difference 824 is transformed, quantised and represented as a transform block (TB), indicated by an arrow 836. The PB 820 and associated TB 836 are typically chosen from one of many possible candidate CBs, for example, based on evaluated cost or distortion.

A candidate coding block (CB) is a CB resulting from one of the prediction modes available to the video encoder 714 for the associated PB and the resulting residual. When combined with the predicted PB in the video encoder 714, the TB 836 reduces the difference between a decoded CB and the original CB 812 at the expense of additional signalling in a bitstream.

Each candidate coding block (CB), that is prediction block (PB) in combination with a transform block (TB), thus has an associated coding cost (or ‘rate’) and an associated difference (or ‘distortion’). The distortion of the CB is typically estimated as a difference in sample values, such as a sum of absolute differences (SAD), a sum of squared differences (SSD) or a Hadamard transform applied to the differences. The estimate resulting from each candidate PB may be determined by a mode selector 886 using the difference 824 to determine a prediction mode 887. The prediction mode 887 indicates the decision to use a particular prediction mode for the current CB, for example, intra-frame prediction or inter-frame prediction. Estimation of the coding costs associated with each candidate prediction mode and corresponding residual coding may be performed at significantly lower cost than entropy coding of the residual. Accordingly, a number of candidate modes may be evaluated to determine an optimum mode in a rate-distortion sense even in a real-time video encoder.

Determining an optimum mode in terms of rate-distortion is typically achieved using a variation of Lagrangian optimisation. Lagrangian or similar optimisation processing can be employed to both select an optimal partitioning of a CTU into CBs (by the block partitioner 810) as well as the selection of a best prediction mode from a plurality of possibilities. Through application of a Lagrangian optimisation process of the candidate modes in the mode selector module 886, the intra prediction mode with the lowest cost measurement is selected as the ‘best’ mode. The lowest cost mode includes a selected secondary transform index 888, which is also encoded in the bitstream 716 by an entropy encoder 838.

In the second stage of operation of the video encoder 714 (referred to as a ‘coding’ stage), an iteration over the determined coding tree(s) of each CTU is performed in the video encoder 714. For a CTU using separate trees, for each 64×64 luma region of the CTU, a luma coding tree is firstly encoded followed by a chroma coding tree. Within the luma coding tree, only luma CBs are encoded and within the chroma coding tree only chroma CBs are encoded. For a CTU using a shared tree, a single tree describes the CUs (i.e., the luma CBs and the chroma CBs) according to the common block structure of the shared tree.

The entropy encoder 838 supports bitwise coding of syntax elements using variable-length and fixed-length codewords, and an arithmetic coding mode for syntax elements. Portions of the bitstream such as ‘parameter sets’, for example, sequence parameter set (SPS) and picture parameter set (PPS) use a combination of fixed-length codewords and variable-length codewords. Slices, also referred to as contiguous portions, have a slice header that uses variable length coding followed by slice data, which uses arithmetic coding. The slice header defines parameters specific to the current slice, such as slice-level quantisation parameter offsets. The slice data includes the syntax elements of each CTU in the slice. Use of variable length coding and arithmetic coding requires sequential parsing within each portion of the bitstream. The portions may be delineated with a start code to form ‘network abstraction layer units’ or ‘NAL units’. Arithmetic coding is supported using a context-adaptive binary arithmetic coding process.

Arithmetically coded syntax elements consist of sequences of one or more ‘bins’. Bins, like bits, have a value of ‘0’ or ‘1’. However, bins are not encoded in the bitstream portion 716 as discrete bits. Bins have an associated predicted (or ‘likely’ or ‘most probable’) value and an associated probability, known as a ‘context’. When the actual bin to be coded matches the predicted value, a ‘most probable symbol’ (MPS) is coded. Coding a most probable symbol is relatively inexpensive in terms of consumed bits in the bitstream portion 716, including costs that amount to less than one discrete bit. When the actual bin to be coded mismatches the likely value, a ‘least probable symbol’ (LPS) is coded. Coding a least probable symbol has a relatively high cost in terms of consumed bits. The bin coding techniques enable efficient coding of bins where the probability of a ‘0’ versus a ‘1’ is skewed. For a syntax element with two possible values (i.e., a ‘flag’), a single bin is adequate. For syntax elements with many possible values, a sequence of bins is needed.

The presence of later bins in the sequence may be determined based on the value of earlier bins in the sequence. Additionally, each bin may be associated with more than one context. The selection of a particular context may be dependent on earlier bins in the syntax element, the bin values of neighbouring syntax elements (i.e., those from neighbouring blocks) and the like. Each time a context-coded bin is encoded, the context that was selected for that bin (if any) is updated in a manner reflective of the new bin value. As such, the binary arithmetic coding scheme is said to be adaptive.

Also supported by the entropy encoder 838 are bins that lack a context, referred to as “bypass bins”. Bypass bins are coded assuming an equiprobable distribution between a ‘0’ and a ‘1’. Thus, each bin has a coding cost of one bit in the bitstream portion 716. The absence of a context saves memory and reduces complexity, and thus bypass bins are used where the distribution of values for the particular bin is not skewed. One example of an entropy coder employing context and adaption is known in the art as CABAC (context adaptive binary arithmetic coder) and many variants of this coder have been employed in video coding.

A QP controller 890 determines a quantisation parameter 892, used to establish a quantisation step size for use by the quantiser 834 and the dequantiser 840. A larger quantisation step size results in the primary transform coefficients 828 being quantised into smaller values, reducing bitrate of the bitstream portion 716 at the expense of a reduction in the fidelity of inverse transform coefficients 846.

The entropy encoder 838 encodes the quantisation parameter 892 and, if in use for the current CB, the LFNST index 888, using a combination of context-coded and bypass-coded bins. The quantisation parameter 892 is encoded at the beginning of each slice and changes in the quantisation parameter 892 within a slice are coded using a ‘delta QP’ syntax element. The delta QP syntax element is signalled at most once in each area known as a ‘quantisation group’. The quantisation parameter 892 is applied to residual coefficients of the luma CB. An adjusted quantisation parameter is applied to the residual coefficients of collocated chroma CBs. The adjusted quantisation parameter may include mapping from the luma quantisation parameter 892 according to a mapping table and a CU-level offset, selected from a list of offsets. The secondary transform index 888 is signalled when the residual associated with the transform block includes significant residual coefficients only in those coefficient positions subject to transforming into primary coefficients by application of a secondary transform.

Residual coefficients of each TB associated with a CB are coded using a residual syntax. The residual syntax is designed to efficiently encode coefficients with low magnitudes, using mainly arithmetically coded bins to indicate significance of coefficients, along with lower-valued magnitudes and reserving bypass bins for higher magnitude residual coefficients. Accordingly, residual blocks comprising very low magnitude values and sparse placement of significant coefficients are efficiently compressed. Moreover, two residual coding schemes are present. A regular residual coding scheme is optimised for TBs with significant coefficients predominantly located in the upper-left corner of the TB, as is seen when a transform is applied. A transform-skip residual coding scheme is available for TBs where a transform is not performed and is able to efficiently encode residual coefficients regardless of their distribution throughout the TB.

A multiplexer module 884 outputs the PB 820 from an intra-frame prediction module 864 according to the determined best intra prediction mode, selected from the tested prediction mode of each candidate CB. The candidate prediction modes need not include every conceivable prediction mode supported by the video encoder 714. Intra prediction falls into three types, first, “DC intra prediction”, which involves populating a PB with a single value representing the average of nearby reconstructed samples; second, “planar intra prediction”, which involves populating a PB with samples according to a plane, with a DC offset and a vertical and horizontal gradient being derived from nearby reconstructed neighbouring samples. The nearby reconstructed samples typically include a row of reconstructed samples above the current PB, extending to the right of the PB to an extent and a column of reconstructed samples to the left of the current PB, extending downwards beyond the PB to an extent; and, third, “angular intra prediction”, which involves populating a PB with reconstructed neighbouring samples filtered and propagated across the PB in a particular direction (or ‘angle’). In VVC, sixty-five (65) angles are supported, with rectangular blocks able to utilise additional angles, not available to square blocks, to produce a total of eighty-seven (87) angles.

A fourth type of intra prediction is available to chroma PBs, whereby the PB is generated from collocated luma reconstructed samples according to a ‘cross-component linear model’ (CCLM) mode. Three different CCLM modes are available, each mode using a different model derived from the neighbouring luma and chroma samples. The derived model is used to generate a block of samples for the chroma PB from the collocated luma samples. Luma blocks may be intra predicted using a matrix multiplication of the reference samples using one matrix selected from a predefined set of matrices. This matrix intra prediction (MIP) achieves gain by using matrices trained on a large set of video data, with the matrices representing relationships between reference samples and a predicted block that are not easily captured in angular, planar, or DC intra prediction modes.

The module 864 may also produce a prediction unit by copying a block from nearby the current frame using an ‘intra block copy’ (IBC) method. The location of the reference block is constrained to an area equivalent to one CTU, divided into 64×64 regions known as VPDUs, with the area covering the processed VPDUs of the current CTU and VPDUs of the previous CTU(s) within each row or CTUs and within each slice or tile up to the area limit corresponding to one 128×128 luma samples, regardless of the configured CTU size for the bitstream. This area is known as an ‘IBC virtual buffer’ and limits the IBC reference area, thus limiting the required storage. The IBC buffer is populated with reconstructed samples 854 (i.e., prior to loop filtering), and so a separate buffer to the frame buffer 872 is needed. When the CTU size is 128×128 the virtual buffer includes samples only from the CTU adjacent and to the left of the current CTU. When the CTU size is 32×32 or 64×64 the virtual buffer includes CTUs from up to the four or sixteen CTUs to the left of the current CTU. Regardless of the CTU size, access to neighbouring CTUs for obtaining samples for IBC reference blocks is constrained by boundaries such as edges of pictures, slices, or tiles. Particularly for feature maps of FPN layers having smaller dimensions, use of a CTU size such as 32×32 or 64×64 results in a reference area more aligned to cover a set of previous feature maps. Where feature map placement is ordered based on SAD, SSE or other difference metric, access to similar feature maps for IBC prediction offers coding efficient advantage.

The residual for a predicted block when encoding feature map data is different to the residual seen for natural video. Natural video is typically captured by an image sensor, or screen content, as generally seen in operating system user interfaces and the like. Feature map residuals tend to contain much detail. The level of detail in feature map residuals is amenable to transform skip coding more than predominantly low-frequency coefficients of various transforms. An intra-predicted luma coding block may be partitioned into a set of equal-sized prediction blocks, either vertically or horizontally, which each block having a minimum area of sixteen (16) luma samples.

Where previously reconstructed neighbouring samples are unavailable, for example at the edge of the frame, a default half-tone value of one half the range of the samples is used. For example, for 10-bit video a value of five-hundred and twelve (512) is used. As no previous samples are available for a CB located at the top-left position of a frame, angular and planar intra-prediction modes produce the same output as the DC prediction mode (i.e. a flat plane of samples having the half-tone value as magnitude).

For inter-frame prediction a prediction block 882 is produced using samples from one or two frames preceding the current frame in the coding order frames in the bitstream by a motion compensation module 880 and output as the PB 820 by the multiplexer module 884. Moreover, for inter-frame prediction, a single coding tree is typically used for both the luma channel and the chroma channels. The order of coding frames in the bitstream may differ from the order of the frames when captured or displayed. When one frame is used for prediction, the block is said to be ‘uni-predicted’ and has one associated motion vector. When two frames are used for prediction, the block is said to be ‘bi-predicted’ and has two associated motion vectors. For a P slice, each CU may be intra predicted or uni-predicted. For a B slice, each CU may be intra predicted, uni-predicted, or bi-predicted.

Frames are typically coded using a ‘group of pictures’ structure, enabling a temporal hierarchy of frames. Frames may be divided into multiple slices, each of which encodes a portion of the frame. A temporal hierarchy of frames allows a frame to reference a preceding and a subsequent picture in the order of displaying the frames. The images are coded in the order necessary to ensure the dependencies for decoding each frame are met. An affine inter prediction mode is available where instead of using one or two motion vectors to select and filter reference sample blocks for a prediction unit, the prediction unit is divided into multiple smaller blocks and a motion field is produced so each smaller block has a distinct motion vector. The motion field uses the motion vectors of nearby points to the prediction unit as ‘control points’. Affine prediction allows coding of motion different to translation with less need to use deeply split coding trees. A bi-prediction mode available to VVC performs a geometric blend of the two reference blocks along a selected axis, with angle and offset from the centre of the block signalled. This geometric partitioning mode (“GPM”) allows larger coding units to be used along the boundary between two objects, with the geometry of the boundary coded for the coding unit as an angle and centre offset. Motion vector differences, instead of using cartesian (x, y) offset, may be coded as a direction (up/down/left/right) and a distance, with a set of power-of-two distances supported. The motion vector predictor is obtained from a neighbouring block (‘merge mode’) as if no offset is applied. The current block will share the same motion vector as the selected neighbouring block.

The samples are selected according to a motion vector 878 and reference picture index. The motion vector 878 and reference picture index applies to all colour channels and thus inter prediction is described primarily in terms of operation upon PUs rather than PBs. The decomposition of each CTU into one or more inter-predicted blocks is described with a single coding tree. Inter prediction methods may vary in the number of motion parameters and their precision. Motion parameters typically comprise a reference frame index, indicating which reference frame(s) from lists of reference frames are to be used plus a spatial translation for each of the reference frames, but may include more frames, special frames, or complex affine parameters such as scaling and rotation. In addition, a pre-determined motion refinement process may be applied to generate dense motion estimates based on referenced sample blocks.

Having determined and selected the PB 820 and subtracted the PB 820 from the original sample block at the subtractor 822, a residual with lowest coding cost, represented as 824, is obtained and subjected to lossy compression. The lossy compression process comprises the steps of transformation, quantisation and entropy coding. A forward primary transform module 826 applies a forward transform to the difference 824, converting the difference 824 from the spatial domain to the frequency domain, and producing primary transform coefficients represented by an arrow 828. The largest primary transform size in one dimension is either a 32-point DCT-2 or a 64-point DCT-2 transform, configured by a ‘sps_max_luma_transform_size_64_flag’ in the sequence parameter set. If the CB being encoded is larger than the largest supported primary transform size expressed as a block size (e.g. 64×64 or 32×32), the primary transform 826 is applied in a tiled manner to transform all samples of the difference 824. Where a non-square CB is used, tiling is also performed using the largest available transform size in each dimension of the CB. For example, when a maximum transform size of thirty-two (32) is used, a 64×16 CB uses two 32×16 primary transforms arranged in a tiled manner. When a CB is larger in size than the maximum supported transform size, the CB is filled with TBs in a tiled manner. For example, a 128×128 CB with 64-pt transform maximum size is filled with four 64×64 TBs in a 2×2 arrangement. A 64×128 CB with a 32-pt transform maximum size is filled with eight 32×32 TBs in a 2×4 arrangement.

Application of the transform 826 results in multiple TBs for the CB. Where each application of the transform operates on a TB of the difference 824 larger than 32×32, e.g., 64×64, all resulting primary transform coefficients 828 outside of the upper-left 32×32 area of the TB are set to zero (i.e., discarded). The remaining primary transform coefficients 828 are passed to a quantiser module 834. The primary transform coefficients 828 are quantised according to a quantisation parameter 892 associated with the CB to produce primary transform coefficients 832. In addition to the quantisation parameter 892, the quantiser module 834 may also apply a ‘scaling list’ to allow non-uniform quantisation within the TB by further scaling residual coefficients according to their spatial position within the TB. The quantisation parameter 892 may differ for a luma CB versus each chroma CB. The primary transform coefficients 832 are passed to a forward secondary transform module 830 to produce transform coefficients represented by the arrow 836 by performing either a non-separable secondary transform (NSST) operation or bypassing the secondary transform. The forward primary transform 826 is typically separable, transforming a set of rows and then a set of columns of each TB. The forward primary transform module 826 uses either a type-II discrete cosine transform (DCT-2) in the horizontal and vertical directions, or bypass of the transform horizontally and vertically, or combinations of a type-VII discrete sine transform (DST-7) and a type-VIII discrete cosine transform (DCT-8) in either horizontal or vertical directions for luma TBs not exceeding 16 samples in width and height. Use of combinations of a DST-7 and DCT-8 is referred to as ‘multi transform selection set’ (MTS) in the VVC standard.

The forward secondary transform of the module 830 is generally a non-separable transform, which is only applied for the residual of intra-predicted CUs and may nonetheless also be bypassed. The forward secondary transform operates either on sixteen (16) samples (arranged as the upper-left 4×4 sub-block of the primary transform coefficients 828) or forty-eight (48) samples (arranged as three 4×4 sub-blocks in the upper-left 8×8 coefficients of the primary transform coefficients 828) to produce a set of secondary transform coefficients. The set of secondary transform coefficients may be fewer in number than the set of primary transform coefficients from which they are derived. Due to application of the secondary transform to only a set of coefficients adjacent to each other and including the DC coefficient, the secondary transform is referred to as a ‘low frequency non-separable secondary transform’ (LFNST). Such secondary transforms may be obtained through a training process and due to their non-separable nature and trained origin, exploit additional redundancy in the residual signal not able to be captured by separable transforms such as variants of DCT and DST. Moreover, when the LFNST is applied, all remaining coefficients in the TB are zero, both in the primary transform domain and the secondary transform domain.

The quantisation parameter 892 is constant for a given TB and thus results in a uniform scaling for producing residual coefficients in the primary transform domain for a TB. The quantisation parameter 892 may vary periodically with a signalled ‘delta quantisation parameter’. The delta quantisation parameter (delta QP) is signalled once for CUs contained within a given area, referred to as a ‘quantisation group’. If a CU is larger than the quantisation group size, delta QP is signalled once with one of the TBs of the CU. That is, the delta QP is signalled by the entropy encoder 838 once for the first quantisation group of the CU and not signalled for any subsequent quantisation groups of the CU. A non-uniform scaling is also possible by application of a ‘quantisation matrix’, whereby the scaling factor applied for each residual coefficient is derived from a combination of the quantisation parameter 892 and the corresponding entry in a scaling matrix. The scaling matrix may have a size that is smaller than the size of the TB, and when applied to the TB a nearest neighbour approach is used to provide scaling values for each residual coefficient from a scaling matrix smaller in size than the TB size. The residual coefficients 836 are supplied to the entropy encoder 838 for encoding in the bitstream portion 716. Typically, the residual coefficients of each TB with at least one significant residual coefficient of the TU are scanned to produce an ordered list of values, according to a scan pattern. The scan pattern generally scans the TB as a sequence of 4×4 ‘sub-blocks’, providing a regular scanning operation at the granularity of 4×4 sets of residual coefficients, with the arrangement of sub-blocks dependent on the size of the TB. The scan within each sub-block and the progression from one sub-block to the next typically follow a backward diagonal scan pattern. Additionally, the quantisation parameter 892 is encoded into the bitstream portion 716 using a delta QP syntax element, and a slice QP for the initial value in a given slice or subpicture and the secondary transform index 888 is encoded in the bitstream portion 716.

As described above, the video encoder 714 needs access to a frame representation corresponding to the decoded frame representation seen in the video decoder. Thus, the residual coefficients 836 are passed through an inverse secondary transform module 844, operating in accordance with the secondary transform index 888 to produce intermediate inverse transform coefficients, represented by an arrow 842. The intermediate inverse transform coefficients 842 are inverse quantised by a dequantiser module 840 according to the quantisation parameter 892 to produce inverse transform coefficients, represented by an arrow 846. A dequantiser module 840 may also perform an inverse non-uniform scaling of residual coefficients using a scaling list, corresponding to the forward scaling performed in the quantiser module 834. The inverse transform coefficients 846 are passed to an inverse primary transform module 848 to produce residual samples, represented by an arrow 850, of the TU. The inverse primary transform module 848 applies DCT-2 transforms horizontally and vertically, constrained by the maximum available transform size as described with reference to the forward primary transform module 826. The types of inverse transform performed by the inverse secondary transform module 844 correspond with the types of forward transform performed by the forward secondary transform module 830. The types of inverse transform performed by the inverse primary transform module 848 correspond with the types of primary transform performed by the primary transform module 826. A summation module 852 adds the residual samples 850 and the PU 820 to produce reconstructed samples (indicated by an arrow 854) of the CU.

The reconstructed samples 854 are passed to a reference sample cache 856 and an in-loop filters module 868. The reference sample cache 856, typically implemented using static RAM on an ASIC to avoid costly off-chip memory access, provides minimal sample storage needed to satisfy the dependencies for generating intra-frame PBs for subsequent CUs in the frame. The minimal dependencies typically include a ‘line buffer’ of samples along the bottom of a row of CTUs, for use by the next row of CTUs and column buffering the extent of which is set by the height of the CTU. The reference sample cache 856 supplies reference samples (represented by an arrow 858) to a reference sample filter 860. The sample filter 860 applies a smoothing operation to produce filtered reference samples (indicated by an arrow 862). The filtered reference samples 862 are used by the intra-frame prediction module 864 to produce an intra-predicted block of samples, represented by an arrow 866. For each candidate intra prediction mode the intra-frame prediction module 864 produces a block of samples, that is 866. The block of samples 866 is generated by the module 864 using techniques such as DC, planar or angular intra prediction. The block of samples 866 may also be produced using a matrix-multiplication approach with neighbouring reference sample as input and a matrix selected from a set of matrices by the video encoder 814, with the selected matrix signalled in the bitstream 716 using an index to identify which matrix of the set of matrices is to be used by the video decoder.

The in-loop filters module 868 applies several filtering stages to the reconstructed samples 854. The filtering stages include a ‘deblocking filter’ (DBF) which applies smoothing aligned to the CU boundaries to reduce artefacts resulting from discontinuities. Another filtering stage present in the in-loop filters module 768 is an ‘adaptive loop filter’ (ALF), which applies a Wiener-based adaptive filter to further reduce distortion. A further available filtering stage in the in-loop filters module 868 is a ‘sample adaptive offset’ (SAO) filter. The SAO filter operates by firstly classifying reconstructed samples into one or multiple categories and, according to the allocated category, applying an offset at the sample level.

Filtered samples, represented by an arrow 870, are output from the in-loop filters module 868. The filtered samples 870 are stored in a frame buffer 872. The frame buffer 872 typically has the capacity to store several (e.g., up to sixteen (16)) pictures and thus is stored in the memory 206. The frame buffer 872 is not typically stored using on-chip memory due to the large memory consumption required. As such, access to the frame buffer 872 is costly in terms of memory bandwidth. The frame buffer 872 provides reference frames (represented by an arrow 874) to a motion estimation module 876 and the motion compensation module 880. The reference frames 874 are output as the reconstructed frame 718 of the corresponding subpicture encoder module 700 (614, 636, 654a, 654b, 654c) and provided to the unpacker module 720. In the example of FIG. 8, the reconstructed frame is a result of operation of lossy VVC encoding, that is due to operation of the modules 810 to 890.

The motion estimation module 876 estimates a number of ‘motion vectors’ (indicated as 878), each being a Cartesian spatial offset from the location of the present CB, referencing a block in one of the reference frames in the frame buffer 872. A filtered block of reference samples (represented as 882) is produced for each motion vector. The filtered reference samples 882 form further candidate modes available for potential selection by the mode selector 886. Moreover, for a given CU, the PU 820 may be formed using one reference block (‘uni-predicted’) or may be formed using two reference blocks (‘bi-predicted’). For the selected motion vector, the motion compensation module 880 produces the PB 820 in accordance with a filtering process supportive of sub-pixel accuracy in the motion vectors. As such, the motion estimation module 876 (which operates on many candidate motion vectors) may perform a simplified filtering process compared to that of the motion compensation module 880 (which operates on the selected candidate only) to achieve reduced computational complexity. When the video encoder 714 selects inter prediction for a CU the motion vector 878 is encoded into the bitstream portion 716.

Although the video encoder 714 of FIG. 8 is described with reference to versatile video coding (VVC), other video coding standards or implementations may also employ the processing stages of modules 810-890. The frame data 712 (and bitstream 121) may also be read from (or written to) memory 206, the hard disk drive 210, a CD-ROM, a Blu-ray Disk™ or other computer readable storage medium. Additionally, the frame data 712 (and bitstream 121) may be received from (or transmitted to) an external source, such as a server connected to the communications network 220 or a radio-frequency receiver. The communications network 220 may provide limited bandwidth, necessitating the use of rate control in the video encoder 120 to avoid saturating the network at times when the frame data 712 is difficult to compress.

The bitstream 121 may be constructed from one or more slices, representing spatial sections (collections of CTUs) of the frame data 712, produced by one or more instances of the video encoder 714, each producing a bitstream portion 716 and operating in a co-ordinated manner under control of the processor 205. The bitstream portion 716 may also contain one slice that corresponds to one subpicture to be output as a collection of subpictures forming one picture, each being independently encodable and independently decodable with respect to any of the other slices or subpictures in the picture. The ability to independently encode and decode any subpicture in the picture allows the affect of lossy compression on the packed feature maps or coefficients contained in any given subpicture to be taken into account in the PCA encoder 160 by using the lossy versions of the feature maps or coefficients in later stages of tensor compression.

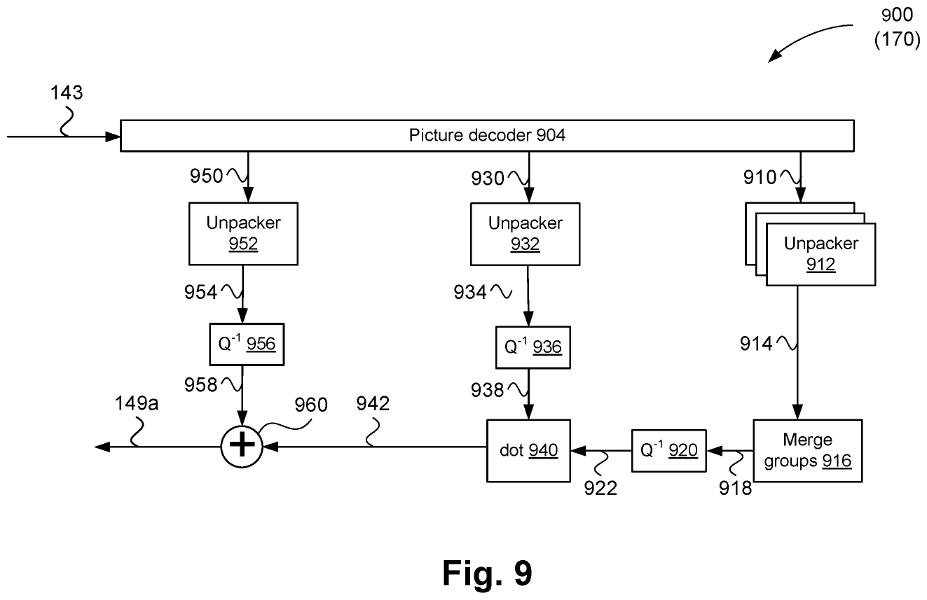

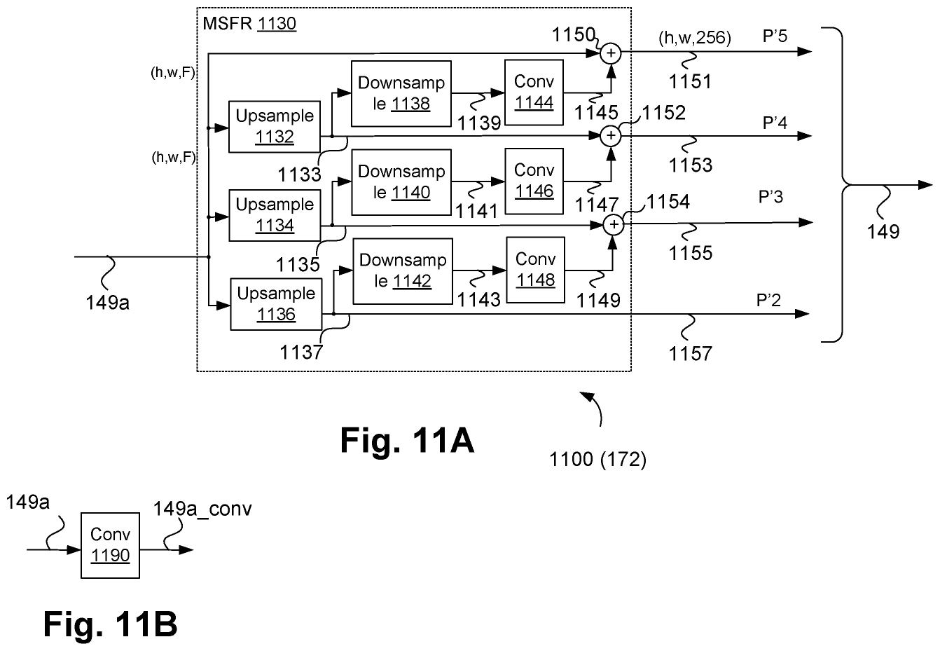

FIG. 9 is a schematic block diagram 900 showing an implementation of the inter-channel decorrelation-based tensor decoder 170. FIG. 11A is a schematic block diagram 1100 showing a multi-scale feature reconstruction (MSFR) module. FIG. 17 is a schematic block diagram showing a method 1700 for decoding tensors. Operation of the decoder side of the system 100 is described with reference to the method 1700. The method 1700 may be implemented using apparatus such as a configured FPGA, an ASIC, or an ASSP. Alternatively, as described below, the method 1700 may be implemented by the destination device 140, as one or more software code modules of the application programs 233, under execution of the processor 205. The software code modules of the application programs 233 implementing the method 1700 may be resident, for example, in the hard disk drive 210 and/or the memory 206. The method 1700 is repeated for each frame of compressed data in the bitstream 123. The method 1700 may be stored on computer-readable storage medium and/or in the memory 206. The method 1700 provides a means of decoding compressed representations of tensors with quality scalability and accurate modelling of inaccuracies introduced due to use of lossy compression mechanisms. The video bitstream 143 is passed to a picture decoder 904, which implements a VVC video decoder and decodes a bitstream generated by the PCA encoder 160. The picture decoder 904 decodes subpictures present in the video bitstream 143, each subpicture corresponding to a different data type needed for producing the tensor 149. Each decoded subpicture provides a unit of information for a decoded tensor, the units corresponding to the mean channel 611, basis vectors, 631 and coefficients 648, with the coefficients 648 coded in multiple groups. The method 1700 begins at a decode coefficient grouping step 1710.

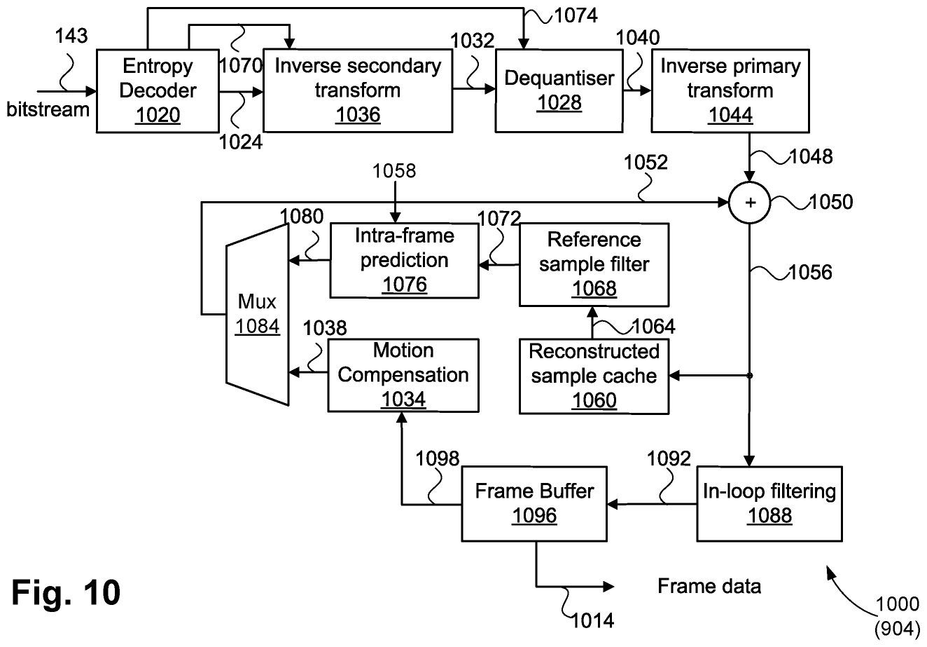

At the step 1710, a picture decoder, such as a VVC decoder, decodes the bitstream 143 under control of the processor 205. As shown in FIG. 9, the inter-channel decorrelation-based tensor decoder 170 includes a picture decoder 904. FIG. 10 shows a VVC decoder 1000 as an example implementation of the picture decoder 904. In the decoder 1000, an entropy decoder 1020, under execution of the processor 205, decodes a coefficient grouping from the bitstream 143. Coefficients form a tensor with channel, width, and height as dimensions. The coefficient grouping divides the coefficients into groups along the channel dimension, such that each group contains a contiguous set of coefficients when coefficients are ordered based on explained variance of the corresponding basis vectors. One group containing the zeroth channel (coefficients for the basis vector with the greatest explained variance) is always present. Between groups there are no unused channels in the coefficients, that is, the groups may be concatenated along the channel dimension to form a single tensor of coefficients for use in projecting, or inverse transforming, back into the same subspace as the original tensor. Although groups are required to contain contiguous sets of coefficients along the channel dimension and include the zeroth channel, it is not required for the least significant channels to be included in any group. For example, if 25 basis vectors are to be used (so coefficients are enumerated as [0 . . . 24]), a group definition could be [0 . . . 4], [5 . . . 9], [10 . . . 14] (omitting coefficients for basis vectors [15 . . . 24].

In decoding the group signalling, the step 1710 operates to decode an assignment that maps an arrangement of independently coded regions of a picture to a plurality of groups of basis vectors. That is, the grouping s subpictures encoded at step 16180 is decoded. Group signalling may be implemented as a list, with each value specifying the number of coefficients along the channel dimension. Since the coefficients are a tensor with c, h, w dimensions, grouping based on a range of channels results in a group containing a number of feature maps, having a width and height for each feature map in the group. Each group in the list starts from the next coefficient after the end of the previous group and terminating the list with a zero-sized group, or exhaustion of available coefficients (whichever occurs first). Control in the processor 205 progresses from the step 1710 to a decode mean channel step 1720.

At the step 1720 the picture decoder 904, under execution of the processor 205, outputs a mean channel subpicture 950, which is passed to an unpacker 952. The unpacker 952 extracts an integer mean channel 954, with C values corresponding to the number of channels in the tensor 149. The integer mean channel 956 is passed to an inverse quantiser 956 where conversion from sample domain to floating-point domain is performed, using a suitable quantisation range, for example obtained from the bitstream 143. Operation of the inverse quantiser 956 results in a decoded mean channel 958. Control in the processor 205 progresses from the step 1720 to a decode basis vectors step 1730.

At the step 1730 the picture decoder 904, under execution of the processor 205, outputs a subpicture 930 containing packed basis vectors that, prior to quantisation and lossy compression, were generated by the decomposition module 630 (e.g., performing a method such as SVD). In other words, the basis vectors are decoded from the bitstream, in the example described in a subpicture packed format. The format may vary based on the dimensionality of the basis vectors and the assignment of coefficients into groups. The subpicture 930 is passed to an unpacker 932. The unpacker 932 extracts integer basis vectors 934 as a series of arrays placed in a non-overlapping manner in the subpicture 930. The integer basis vectors 934 are passed to an inverse quantiser 936. The inverse quantiser 936 constructs floating-point basis vectors 938, applying a quantisation range obtained from the bitstream 143. The decoded assignment provides an indication of which basis vectors are to have corresponding coefficients in a feature frame, as not all subpictures may have been selected at step 1670. Control in the processor 205 progresses from the step 1730 to a decode coefficients step 1740.

At the step 1740 the picture decoder 904, under execution of the processor 205, outputs coefficient subpictures 910. The coefficient subpictures 910 are passed to an unpacker 912. Each subpicture contains one or more feature maps corresponding to coefficients of one group as decoded at the step 1710. In other words, the subpictures 910 contain coefficients, with one coefficient per sample per basis vector of the tensor 143. The subpictures 910 are output by the picture decoder 904 and passed to an unpacker 912. The unpacker 912 extracts each coefficient from the subpictures 910 based on the dimensionality of the tensor 149 and the grouping from the step 16100, outputting integer coefficients tensors 914. Due to selection of a subset of the groups at the step 16170 the subpictures 910 may not contain coefficients corresponding to all basis vectors. In decoding the subpictures 910, a feature frame can be considered to be decoded from the bitstream. The feature frame contains independently coded regions (subpictures), including regions having coefficients corresponding to one or more basis vectors decoded at step 1730. Regions may also encode the basis vectors and the mean channel values.

Control in the processor 205 progresses from the step 1740 to a merge coefficients step 1750.

As noted above, coefficients form a tensor with channel, width, and height as dimensions. In other words, coefficients are decoded from the bitstream and extracted from the feature frame as feature maps (with one feature map per channel) forming a coefficient tensor. At the step 1750 a merge groups module 916, under execution of the processor 205, concatenates coefficient groups tensors 914 along the channel dimension to produce an integer coefficient tensor 918. Control in the processor 205 progresses from the step 1750 to an inverse quantise coefficients step 1760.

At the step 1760 an inverse quantiser 920, under execution of the processor 205, converts the integer coefficients tensor 918 from the integer domain to the floating-point domain according to a quantisation range obtained from the bitstream 143, outputting floating-point coefficients 922. The step 1760 operates to obtain coefficients from the decoded feature frame by the inverse quantisation operation. Control in the processor 205 progresses from the step 1760 to a produce tensor step 1770.

At the step 1770 a zero-centred tensor 942 is produced by a dot product module 940, under execution of the processor 205, by performing a dot product on the coefficients 922 and the basis vectors 938. A summation module 960 adds the zero-centred tensor 942 with the mean channel 958 to produce the reconstructed combined tensor 149a as output from the PCA decoder 170. Completion of step 1770 effectively produces the tensor 149a from the coefficients tensor and the set of basis vectors decoded at operation of steps 1710 to 1750. The combined tensor 149a has the same spatial size and a higher channel count than the coefficients tensor. The tensor 149a can also be considered a projection of the coefficients and the basis vectors produced using a dot product operation, for example using the module 940. Control in the processor 205 progresses from the step 1770 to a reconstruct tensors step 1780.

The architecture 1100 includes a MSFR module 1130. The MSFR module operates to produce a plurality of tensors from the tensor 149a produced by execution of step 1770 using one or more trained convolutional layers. At the step 1780 the reconstructed tensor 149 is generated from the reconstructed combined tensor 149a by the MSFR module 1130. Upsample modules 1132, 1134, and 1136 upsample the tensor 149a horizontally and vertically by factors of two, four, and eight, respectively, to produce tensors 1133, 1135, and 1137. The tensor 1137 forms one (P′2) output from the MSFR module 1130 and is passed to a downsample module 1142. The downsample module 1142 downsamples the tensor 1137 by a factor of two horizontally and vertically to produce a tensor 1143 having the same dimensionality as the tensor 1135. The tensor 1143 is provided to a convolution layer 1148 which outputs a tensor 1149. A summation module 1154 adds the tensors 1135 and 1149 to produce the tensor 1155 as an output (P′3) of the MSFR module 1130.

A downsample module 1140 downsamples the tensor 1135 by a factor of two horizontally and vertically to produce a tensor 1141 having the same dimensionality as the tensor 1133. The tensor 1141 is provided to a convolution layer 1146 which outputs a tensor 1147. A summation module 1152 adds the tensors 1133 and 1147 to produce the tensor 1153 as an output (P′4) of the MSFR module 1130.

A downsample module 1138 downsamples the tensor 1133 by a factor of two horizontally and vertically to produce a tensor 1139 having the same dimensionality as the tensor 149a. The tensor 1139 is provided to a convolution layer 1144 which outputs a tensor 1145. A summation module 1150 adds the tensors 149a and 1145 to produce the tensor 1151 as an output (P′5) of the MSFR module 1130. Collectively, the tensors 1151, 1153, 1155, and 1157 form tensors 149 and provide the decoded P2-P5 layers. Control in the processor 205 progresses from the step 1780 to a perform neural network second portion step 1790.

In an alternative embodiment of the architecture 1100, the tensors 149a are input to a convolutional neural network, and the output of the convolutional neural network is input to the upsamplers 1132, 1134 and 1136. For example, FIG. 11B shows the tensor 149a being input to a trained convolutional layer 1190 and an output 149a_conv being produced. In the arrangements using the convolutional layer 1190, the output 149a_conv is input to the upsamplers 1132, 1134 and 1136. The convolutional layer 1190 had fewer output channels than input channels and, as shown is applied to the tensor 149a prior to producing a plurality of tensors by the MSFR module 1130. Implementations using the convolutional layer 1190 correspond to implementations in which the convolutional layer 528 are excluded from the module 500 on the encoding side. Whether the layer 1190 is used or not, the trained convolutional layers of FIGS. 11A and 11B implement spatial resizing to recover the hierarchical representation (FPN) of the frame.

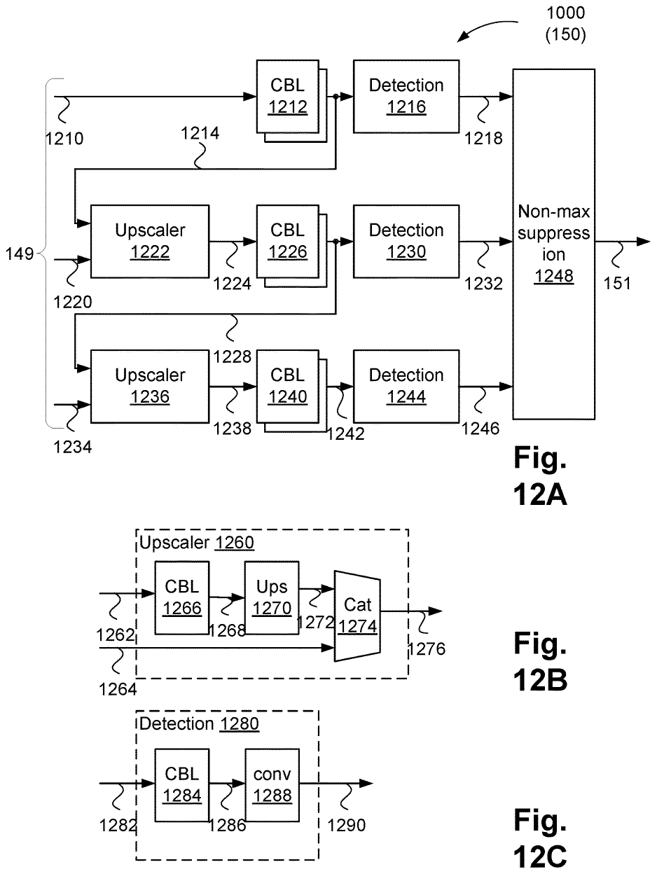

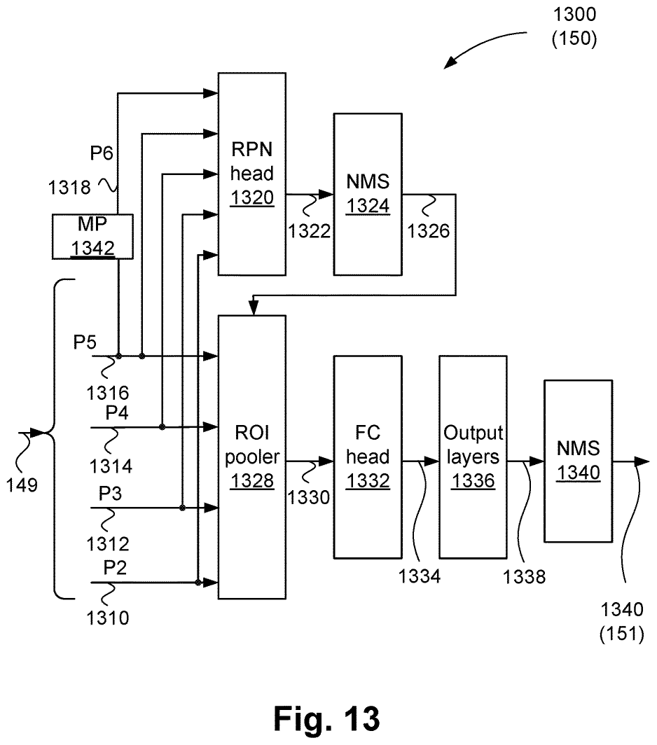

At the step 1790 the CNN head 150, under execution of the processor 205, performs the second portion of the neural network task. Example second or head portions 150 are described with reference to FIGS. 12A-C and FIG. 13. The method 1700 terminates processing for the current frame and is invoked again for the next received frame in the bitstream 143.

In an arrangement of the method 1700, subpictures for groups that were not selected for inclusion in the bitstream are decoded as flat regions coded with a neutral value, such as a DC mid-tone value. A quantisation range that results in the DC mid-tone value corresponding to an inverse quantised floating-point value of 0.0 is used. The method 1700 may process all subpictures, including those that were omitted by replacement with a neutral value, and perform the projection from the basis vector subspace back to the subspace of the tensor 115, without knowledge of which specific groups are used for a given frame. Absence of different treatment for included vs omitted groups of coefficients is possible because the subpictures containing coefficients coded with the neutral value do not influence the final reconstructed combined tensor 149.

The example implementation 1000 of the picture decoder 904, also referred to as a video decoder, is shown in FIG. 10. Although the video decoder 904 of FIG. 9 is an example of a versatile video coding (VVC) video decoding pipeline, other video codecs may also be used to perform the processing stages described herein, for example HEVC and the like. As shown in FIG. 10, a bitstream 143 is input to the video decoder 804. The bitstream 143 may be read from memory 206, the hard disk drive 210, a CD-ROM, a Blu-ray Disk™ or other non-transitory computer readable storage medium and provided as the bitstream 143 to the implementation 1000. Alternatively, the bitstream 143 may be received from an external source such as a server connected to the communications network 220 or a radio-frequency receiver. The bitstream 143 contains encoded syntax elements representing the captured frame data to be decoded. Where subpictures are independently decoded, portions of the bitstream 143 corresponding to each subpicture may be supplied to separate instances of the implementation 1000. Separate instances of the implementation 1000 for each subpicture allows parallel decoding of subpictures for improved throughput.

The bitstream 143 is input to an entropy decoder module 1020. The entropy decoder module 1020 extracts syntax elements from the bitstream 1010 by decoding sequences of ‘bins’ and passes the values of the syntax elements to other modules in the video decoder 904. The entropy decoder module 1020 uses variable-length and fixed length decoding to decode SPS, PPS or slice header an arithmetic decoding engine to decode syntax elements of the slice data as a sequence of one or more bins. Each bin may use one or more ‘contexts’, with a context describing probability levels to be used for coding a ‘one’ and a ‘zero’ value for the bin. Where multiple contexts are available for a given bin, a ‘context modelling’ or ‘context selection’ step is performed to choose one of the available contexts for decoding the bin. The process of decoding bins forms a sequential feedback loop, thus each slice may be decoded in the slice's entirety by a given entropy decoder 1020 instance. A single (or few) high-performing entropy decoder 1020 instances may decode all slices or subpictures for a frame or picture from the bitstream 1010 multiple lower-performing entropy decoder 1020 instances may concurrently decode the slices for a frame from the bitstream 1010.

The entropy decoder module 1020 applies an arithmetic coding algorithm, for example ‘context adaptive binary arithmetic coding’ (CABAC), to decode syntax elements from the bitstream 1010. The decoded syntax elements are used to reconstruct parameters within the video decoder 904. Parameters include residual coefficients (represented by an arrow 1024), a quantisation parameter 1074, a secondary transform index 1070, and mode selection information such as an intra prediction mode (represented by an arrow 1058). The mode selection information also includes information such as motion vectors, and the partitioning of each CTU into one or more CBs. Parameters are used to generate PBs, typically in combination with sample data from previously decoded CBs.

The residual coefficients 1024 are passed to an inverse secondary transform module 1036 where either a secondary transform is applied or no operation is performed (bypass) according to a secondary transform index. The inverse secondary transform module 1036 produces reconstructed transform coefficients 1032. That is, the module 1036 produces primary transform domain coefficients from secondary transform domain coefficients. The reconstructed transform coefficients 1032 are input to a dequantiser module 1028. The dequantiser module 1028 performs inverse quantisation (or ‘scaling’) on the residual coefficients 1032, that is, in the primary transform coefficient domain, to create reconstructed intermediate transform coefficients, represented by an arrow 1040, according to the quantisation parameter 1074. The dequantiser module 1028 may also apply a scaling matrix to provide non-uniform dequantization within the TB, corresponding to operation of the dequantiser module 840. Should use of a non-uniform inverse quantisation matrix be indicated in the bitstream 143, the video decoder 904 reads a quantisation matrix from the bitstream 143 as a sequence of scaling factors and arranges the scaling factors into a matrix. The inverse scaling uses the quantisation matrix in combination with the quantisation parameter to create the reconstructed intermediate transform coefficients 1040.

The reconstructed transform coefficients 1040 are passed to an inverse primary transform module 1044. The module 1044 transforms the coefficients 1040 from the frequency domain back to the spatial domain. The inverse primary transform module 1044 applies inverse DCT-2 transforms horizontally and vertically, constrained by the maximum available transform size as described with reference to the forward primary transform module 826. The result of operation of the module 1044 is a block of residual samples, represented by an arrow 1048. The block of residual samples 1048 is equal in size to the corresponding CB. The residual samples 1048 are supplied to a summation module 1050.

At the summation module 1050 the residual samples 1048 are added to a decoded PB (represented as 1052) to produce a block of reconstructed samples, represented by an arrow 1056. The reconstructed samples 1056 are supplied to a reconstructed sample cache 1060 and an in-loop filtering module 1088. The in-loop filtering module 1088 produces reconstructed blocks of frame samples, represented as 1092. The frame samples 1092 are written to a frame buffer 1096. The frame buffer 1096 outputs image or video frames 1014 corresponding to the tensors 149 of FIG. 1.

The reconstructed sample cache 1060 operates similarly to the reconstructed sample cache 856 of the video encoder 714. The reconstructed sample cache 1060 provides storage for reconstructed samples needed to intra predict subsequent CBs without the memory 206 (e.g., by using the data 232 instead, which is typically on-chip memory). Reference samples, represented by an arrow 1064, are obtained from the reconstructed sample cache 1060 and supplied to a reference sample filter 1068 to produce filtered reference samples indicated by arrow 1072. The filtered reference samples 1072 are supplied to an intra-frame prediction module 1076. The module 1076 produces a block of intra-predicted samples, represented by an arrow 1080, in accordance with the intra prediction mode parameter 1058 signalled in the bitstream 1010 and decoded by the entropy decoder 1020. The intra prediction module 1076 supports the modes of the encoder-side module 864, including IBC and MIP. The block of samples 1080 is generated using modes such as DC, planar or angular intra prediction.

When the prediction mode of a CB is indicated to use intra prediction in the bitstream 143, the intra-predicted samples 1080 form the decoded PB 1052 via a multiplexor module 1084. Intra prediction produces a prediction block (PB) of samples, which is a block in one colour component, derived using ‘neighbouring samples’ in the same colour component. The neighbouring samples are samples adjacent to the current block and by virtue of being preceding in the block decoding order have already been reconstructed. Where luma and chroma blocks are collocated, the luma and chroma blocks may use different intra prediction modes. However, the two chroma CBs share the same intra prediction mode.

When the prediction mode of the CB is indicated to be inter prediction in the bitstream 143, a motion compensation module 1034 produces a block of inter-predicted samples, represented as 1038. The block of inter-predicted samples 1038 are produced using a motion vector, decoded from the bitstream 143 by the entropy decoder 1020, and reference frame index to select and filter a block of samples 1098 from the frame buffer 1096. The block of samples 1098 is obtained from a previously decoded frame stored in the frame buffer 1096. For bi-prediction, two blocks of samples are produced and blended together to produce samples for the decoded PB 1052. The frame buffer 1096 is populated with filtered block data 1092 from an in-loop filtering module 1088. As with the in-loop filtering module 868 of the video encoder 714, the in-loop filtering module 1088 applies any of the DBF, the ALF and SAO filtering operations. Generally, the motion vector is applied to both the luma and chroma channels, although the filtering processes for sub-sample interpolation in the luma and chroma channel are different.

Not shown in FIGS. 8 and 10 is a module for preprocessing video prior to encoding and postprocessing video after decoding to shift sample values such that a more uniform usage of the range of sample values within each chroma channel is achieved. A multi-segment linear model is derived in the video encoder 714 and signalled in the bitstream for use by the video decoder 904 to undo the sample shifting. The linear-model chroma scaling (LMCS) tool provides compression benefit for particular colour spaces and content that have some nonuniformity, especially utilisation of a limited range, in their utilisation of the sample space that may result in higher quality loss from application of quantisation.

FIG. 12A is a schematic block diagrams showing an example implementation 1200 of the head portion 150 of a CNN for object detection, corresponding to a portion of a “YOLOv3” network excluding the “DarkNet-53” backbone portion. The implementation 1200 can be used when the CNN backbone is implemented as in FIG. 3A for example. Depending on the task to be performed in the destination device 140, different networks may be substituted for the CNN head 150. Incoming tensors 149 are separated into the tensor of each layer (i.e., tensors 1210, 1220, and 1234). The tensor 1210 is passed to a CBL module 1212 to produce tensor 1214. The tensor 1214 is passed to a detection module 1216 and an upscaler module 1222. The detection module outputs bounding boxes 1218, in the form of a detection tensor. The bounding boxes 1218 are passed to a non-maximum suppression (NMS) module 1248.

To produce bounding boxes addressing co-ordinates in the original video data 113, prior to resizing for the backbone portion of the network 114, scaling by the original video width and height is performed at the upscaler module 1222. The upscaler module 1222 receives the tensor 1214 and the tensor 1220 and produces an upscaled tensor 1224, which is passed to a CBL module 1226. The CBL module 1226 produces a tensor 1228 as output. The tensor 1228 is passed to a detection module 1230 and an upscaler module 1236. The detection module 1230 produces a detection tensor 1232, which is supplied to the NMS module 1248. The upscaler module 1236 is another instance of the module 1222. The upscaler module 1236 receives the tensor 1228 and the tensor 1234 and outputs an upscaled tensor 1238. The upscaled tensor 1238 is passed to a CBL module 1240, which outputs a tensor 1242 to a detection module 1244.

The CBL modules 1212, 1226, and 1240 each contain a concatenation of five CBL modules, for example the CBL model 360 shown in FIG. 3D. The upscaler modules 1222 and 1236 are each instances of an upscaler module 1260 as shown in FIG. 12B. The module 1248 receives the tensors 1218, 1232 and 1236 and outputs the task result 151.

As shown in FIG. 12B, the upscaler module 1260 accepts a tensor 1262 (for example the tensor 1214 of FIG. 12A) as an input. The tensor 1262 is passed to a CBL module 1266 (having structure of the module 360) to produce a tensor 1268. The tensor 1268 is passed to an upsampler 1270 to produce an upsampled tensor 1272. A concatenation module 1274 produces a tensor 1276 by concatenating the upsampled tensor 1272 with a second input tensor 1264 (for example the tensor 1220 input to the upscaler 1222 in FIG. 12A).

The detection modules 1216, 1230, and 1244 are instances of a detection module 1280 as shown in FIG. 12C. The detection module 1280 receives a tensor 1282. The tensor 1282 is input to a CBL module 1284 having structure of the module 360. The CBL module 1284 generates a tensor 1286. The tensor 1286 is passed to a convolution module 1288, which implements a detection kernel. In some arrangements, the detection kernel applies a 1×1 kernel to produce the output on feature maps at each of the three layers of the tensor. The detection kernel is 1×1×(B×(5+C)), where B is the number of bounding boxes a particular cell can predict, typically three (3), and C is the number of classes, which may be eighty (80), resulting in a kernel size of two-hundred and fifty five (255) detection attributes (i.e. tensor 1090). The constant “5” represents four boundary box attributes (box centre x, y and size scale x, y) and one object confidence level (“objectness”). The result of a detection kernel has the same spatial dimensions as the input feature map, but the depth of the output corresponds to the detection attributes. The detection kernel is applied at each layer, typically three layers, resulting in a large number of candidate bounding boxes. A process of non-maximum suppression is applied by the NMS module 1048 to the resulting bounding boxes to discard redundant boxes, such as overlapping predictions at similar scale, resulting in a final set of bounding boxes as output for object detection.

FIG. 13 is a schematic block diagram showing an alternative head portion 1300 of a CNN. The head portion 1300 can be implemented as the CNN head 150 where the CNN backbone 114 is implemented as the backbone 400 for example. The head portion 1300 forms part of an overall network known as ‘faster RCNN’ and includes a feature network (i.e., backbone portion 400), a region proposal network, and a detection network. Input to the head portion 1300 are the tensors 149, which include the P2-P6 layer tensors 1310, 1312, 1314, 1316, and 1318. The P2-P5 layer tensors 1310, 1312, 1314, and 1316, correspond to the P2 to P5 outputs 477, 475, 473, and 471 of FIG. 4. The P2-P6 tensors 1310, 1312, 1314, 1316, and 1318 are input to a region proposal network (RPN) head module 1320. The P6 tensor 1318 is produced by max pool module 1342, operating on P5 tensor 1316 to perform a 2×2 max pooling operation. The RPN head module 1320 performs a convolution on the input tensors, generating an intermediate tensor. The intermediate tensor is fed into two subsequent sibling layers, (i) one for classifications and (ii) one for bounding box, or ‘region of interest’ (ROI), regression. A resultant output is classification and bounding boxes 1322. The classification and bounding boxes 1322 are passed to an NMS module 1324. The NMS module 1324 prunes out redundant bounding boxes by removing overlapping boxes with a lower score to produce pruned bounding boxes 1326. The bounding boxes 1326 are input to a region of interest (ROI) pooler 1328. The ROI pooler 1328 uses some of the layer tensors of the tensor 149 (described further hereafter) and the bounding boxes 1326 to produce fixed-size feature maps from various input size maps using max pooling operations. In the max pooling operation a subsampling takes the maximum value in each group of input values to produce one output value in the output tensor.

Input to the ROI pooler 1328 are the P2-P5 feature maps 1310, 1312, 1314, and 1316, and region of interest proposals 1326. Each proposal (ROI) from 1326 is associated with a portion of the feature maps (1310-1316) to produce a fixed-size map. The fixed-size map is of a size independent of the underlying portion of the feature map 1310-1316. One of the feature maps 1310-1316 is selected such that the resulting cropped map has sufficient detail, for example, according to the following rule: floor (4+log 2(sqrt(box_area)/224)), where 224 is the canonical box size. The ROI pooler 1328 operates to crop incoming feature maps according to the proposals 1326 producing a tensor 1330.

The tensor 1330 is fed into a fully connected (FC) neural network head 1332. The FC head 1332 performs two fully connected layers to produce class score and bounding box predictor delta tensor 1334. The class score is generally an 80-element tensor, each element corresponding to a prediction score for the corresponding object category. The bounding box prediction deltas tensor is an 80×4=320 element tensor, containing bounding boxes for the corresponding object categories. Final processing is performed by an output layers module 1336, receiving the tensor 1334 and performing a filtering operation to produce a filtered tensor 1338. Low-scoring (low classification) objects are removed from further consideration. A non-maximum suppression module 1340 receives the filtered tensor 1338 and removes overlapping bounding boxes by removing the overlapped box with a lower classification score, resulting in an inference output tensor 1340, corresponding to the tensor 151.

FIG. 14A is a schematic block diagram showing a division of a picture 1400 into subpictures 1410, 1412, and 1416a, 1416b, and 1416c, as implemented by the subpicture bitstream combiner 680 for example. Each subpicture is packed by a packer 710 of the corresponding one of encoders 614, 636, 654a, 654b, and 654c. The example of FIGS. 14A and 14B shows coefficients divided into three groups and hence using three subpictures. However in other implementations different numbers of groups are also possible. Each subpicture includes information arranged in a two-dimensional array of samples. Referring to FIG. 14B, the picture 1400b corresponds to the picture 1400, subpicture 1410b corresponds to 1410 and 1412b corresponds to 1412. The subpicture 1410b holds mean channel data, such as a mean channel 1420 for the tensor 115. The mean channel 1410b corresponds to bitstream 615 of the subpicture encoder 614 in the arrangement of FIG. 6. Subpicture 1412b holds basis vectors, corresponding to 637 of FIG. 6. In the example of FIG. 14B the basis vectors include basis vector 1422 amongst others, with the basis vectors packed into the area of the subpicture 1412b in a non-overlapping manner. Area in the picture 1400 (or 1400b) that is not used to store any data may be occupied by sample values corresponding to the value ‘0’ after application of inverse quantisation to convert from sample values back to the floating-point domain. Similarly, area in the subpictures 1410 (or 1410b), 1412 (or 1412b), 1416a, 1416b, and 1416c that is not used to store any data, may be occupied by sample values corresponding to the value ‘O’ after application of inverse quantisation to convert from sample values back to the floating-point domain. The subpictures 1416a, 1416b, and 1416c hold coefficient groups corresponding to 654a, 654b, and 654c of FIG. 6, with coefficient for each basis vector forming a width by height feature map. For example, in the first coefficient group as represented in subpicture 1416a having ten basis vectors, coefficients for one tensor are arranged as ten feature maps (applicable to basis vectors [0.9]), such as feature map 1430, each one having width and height corresponding to that of the tensor 115. The coefficient subpicture 1416b has coefficients packed as four feature maps (applicable to basis vectors [10 . . . 14]), such as feature map 1432. The coefficient subpicture 1416c has 10 feature maps (applicable to basis vectors [15 . . . 25]), such as feature map 1434.

FIG. 15 is a schematic block diagram showing a bitstream 1500 holding encoded packed feature maps and associated metadata. The bitstream 1500 corresponds to the bitstream 121 produced by the PCA encoder 160 or the bitstream 143 decoded by the PCA decoder 170. The bitstream 1500 contains groups of syntax prefaced by a ‘network abstraction layer’ (NAL) unit header. For example, a NAL unit header 1508 precedes a sequence parameter set (SPS) 1510. The SPS 1510 specifies the layout of the picture 1400, including the positions and sizes of subpictures 1410, 1412, 1416a, 1416b, and 1416c, using subpicture information 1511. The SPS 1510 also indicates the chroma format, the bit depth, the resolution of the frame data represented by the bitstream 1500. If at step 16160 N is adjusted, the coefficient grouping encoded at step 16180 is adjusted to commence a new subpicture structure.

The coefficient grouping used by the PCA encoder 160 may be encoded in an SEI message 1513, using a list to divide the coefficients tensor into groups along the channel dimension, coded as coefficient grouping information 1591. The size (i.e., width and height) of the coefficient feature maps are also encoded as part of the coefficient grouping info 1591 in the SEI message 1513. Quantisation ranges, as determined in the quantisers 612, 632, 646 are coded as quantisation ranges 1592.

A picture 1514 is encoded in the bitstream 1500. Each picture includes one or more subpictures, such as coded subpicture 1520, encoding subpicture 1410 (or 1410b). For the first picture of a bitstream and for an IDR picture intra slices are used, avoiding any prediction dependency on other access units in the bitstream 1500. A coded subpicture 1522 encoding subpicture 1412, includes a slice header 1530 followed by slice data 1540. The slice data 1540 includes a sequence of CTUs, providing the coded representation of the frame data. The CTU is square and typically 128×128 in size, which is not well aligned to typical feature map sizes. The alignment of feature maps to a minimum block size, such as a 4×4 grid partially ameliorates this misalignment. Coded subpictures 1524, 1526, and 1528 encode subpictures 1416a, 1416b, and 1416c, corresponding to respective groups of coefficients.

In an arrangement of the method 1600, the determine basis vectors step 1650 is performed less frequently than on every frame. When basis vectors are not determined for a particular frame, basis vectors from an earlier frame are used. The step 1650 may be performed infrequently, such as once at the start of a video sequence or periodically, such as every time the frame is to be coded using intra prediction (such as a new IDR picture or an intra picture in a random access picture structure). When the step 1650 is performed, for each basis vector an amount of explained variance for the respective basis vector is also derived. The degree of explained variance may form a basis for determining grouping of coefficients and/or ordering regions or subpictures. Where the step 1650 is performed and the difference in the explained variances relative to that determined at the previous performance of the step 1650 exceeds a threshold, the source device 110 may derive a new grouping and hence a new division of the picture 1400 into subpictures. When a division of the picture 1400 into subpictures is performed, an IDR picture needs to be sent to signal the division, and an instance of the SEI message 1513 is signalled to indicate the division of coefficients into groups that utilises the defined subpicture structure.

In an arrangement of the method 1600, when packing coefficient feature maps into the last subpicture, i.e., 1416c, a variable number of coefficient feature maps are packed, providing a fine-granularity mechanism for rate control. As the last subpicture tends to be large in size, in order to occupy unused area in the picture 1400, coding all coefficient feature maps for this would result in a coarse granularity of added rate for including this subpicture in the bitstream 121. The iterative method of the steps 16120-16170 may be performed within the last subpicture to determine how many coefficient feature maps to use. Once the number of coefficient feature maps to use is determined, the last subpicture (1416c) may be re-encoded with only the used coefficient feature maps packed into the subpicture area).

In the example arrangements described, the tensor combiner 162 is implemented as the MSFF module 500 and the tensor separator 172 is implemented as the MSFR module 1130, both of which involve trained layers in their operation. In an alternative arrangement, tensor combiner 162 may combine two layers by resampling the tensor for one layer and concatenating the resulting tensor with the tensor of another layer, e.g., and adjacent layer in the FPN, producing the combined tensors 115 at step 1615. The number and dimensionality of the tensors may be stored as layer mapping in the SEI message 1513. In the alternative implementation, the tensor separator 172 performs the inverse operation of the tensor combiner 162, to produce the extracted tensors 149 based on the layer mapping of the decoded SEI message. Where an FPN includes multiple layers, such as four layers, the layers may be treated as two sets of layers and processed by separate instances of the tensor combiner 162, the PCA encoder 160, the PCA decoder 170, and the tensor separator 172. Layers P2 and P3 may be treated as one set and layers P4 and P5 may be treated as another set. Despite treatment as separate sets of layers, associated mean channel tensors, basis vectors, and coefficients for each set may be packed into a single feature frame.

Irrespective of the methods used, the tensor combiner 162 operates to fuse a plurality of tensors forming a hierarchical representation together, generally from a FPN, into a single tensor amenable to decorrelation using PCA methods. Each tensor output in the tensors 115a forms part of a dividing point of the network that is split into the first (backbone 114) portion and second (head 150) portion. If a FPN is not used, the first portion and second portion do not include a hierarchical representation of an input to the first portion.

Methods presented herein enable efficient representation of tensors in a format being amenable to compression using contemporary block-based compression standards such as VVC or HEVC. Block-based compression, although not intuitively applicable to data such as coefficients for projecting basis vectors to reconstruct feature maps, uncover additional unexpected redundancy in blocks such as by use of various transforms including trained secondary transforms. Although methods presented herein are described with reference to the ‘Faster RCNN’ and ‘YOLOv3’ network architectures and specific divisions of these networks into ‘backbone’ and ‘head’ portions, the methods are applicable to any neural network operating on multi-dimensional tensor data, and are applicable to different divisions of such networks into ‘backbone’ and ‘head’ portions.

### INDUSTRIAL APPLICABILITY

The arrangements described are applicable to the computer and data processing industries and particularly for the digital signal processing for the encoding and decoding of signals such as video and image signals, achieving high compression efficiency.

Arrangements for quantising floating-point tensor data in groups of channels, or feature maps, and packing the resulting integer values into planar frames using a logarithmic quantised domain are also disclosed. Quantisation and inverse quantisation methods employing a logarithmic quantised domain enable greater compression efficiency due to the absence of bits spent encoding precise values for large magnitude tensor values, where such precision does not result in additional improvement in task performance for the network in use.

In some arrangements described, MFSC feature compression or expansion is used in association with PCA encoding or decoding, respectively. Traditional use of MFSC techniques including three main modules of MSFF, SSFC (encoder and decoder), and MSFR can provide performance at a cost of high training requirements and decreased flexibility due to the training requirements. Traditional techniques using PCA can suffer from performance when fewer coefficients are used, resulting in a reduced utilised area of a feature frame. In combining PCA with use of trained convolutional layers for feature compression including MSFF, PCA, and MSFR, suitable accuracy can be achieved without incur higher training requirements. Additionally, use of PCA allows scalability that is not possible with MFSC only as the number of basis vectors for which coefficients are encoded can be varied between frames, and as the PCA can include analysis of error. Further, basis vectors can be updated on an intermittent basis, or can be determine less frequently for any frame.

In other arrangements, PCA is implemented in a channel-wise manner such that only some groups or subpictures are selected for encoding. As described hereinbefore, selecting, and therefor packing, a variable number of coefficient feature maps can provide a fine-granularity mechanism for rate control.

The foregoing describes only some embodiments of the present invention, and modifications and/or changes can be made thereto without departing from the scope and spirit of the invention, the embodiments being illustrative and not restrictive.

1. A method of encoding a tensor for a single frame into a bitstream, the method comprising:
producing coefficients for the tensor using a plurality of basis vectors, the coefficients forming one feature map for each basis vector of the plurality of basis vectors;
producing an assignment that groups coefficients according to the respective one of the basis vector for the coefficients;
encoding the coefficients into a feature frame bitstream such that each group of coefficients is decoded independently; and
encoding the assignment into the bitstream and setting a subpicture arrangement based on the assignment to encode the tensor.

2. The method of claim 1, wherein when it is determined to update the assignment, a new subpicture structure is commenced.

3. The method of claim 1, wherein one or more groups of coefficients are selected based on a distance metric between the tensor and projections of the one or more groups of coefficients with the plurality of basis vectors;
and encoding portions of the feature frame bitstream corresponding to the selected one or more groups of coefficients.

4. The method of claim 1, wherein the tensor is the result of fusing a plurality of tensors forming a hierarchical representation together.

5. The method of claim 1, wherein the tensor is the sole dividing point of a network that is split into a first portion and second portion.

6. The method of claim 1, wherein the first portion and second portion do not include a hierarchical representation of an input to the first portion.

7. The method of claim 1, wherein the assignment is produced using coefficients obtained from the feature frame.

8. A method of decoding a tensor for a single frame from a bitstream, the method comprising:
decoding an assignment that maps an arrangement of independently coded regions of a picture to a plurality of groups of basis vectors;
decoding a feature frame from the bitstream wherein the feature frame contains a plurality of independently coded regions, each region containing coefficients corresponding to one or more basis vectors of a plurality of basis vectors according to the assignment;
obtaining coefficients from the decoded feature frame by inverse quantising samples from the feature frame; and
producing the decoded tensor using the basis vectors and the decoded coefficients.

9. The method according to claim 8, wherein the assignment provides an indication of which basis vectors of a plurality of basis vectors are to have corresponding coefficients in a feature frame, and the decoding of the feature frame uses the indication.

10. The method according to claim 8, wherein the independently coded regions are ordered based on explained variance of the basis vectors in each region.

11. The method according to claim 8, wherein the indication results in the use of a contiguous subset of the one or more coded regions including the coded region with basis vectors having the highest explained variance.

12. An encoder for encoding a tensor for a single frame into a bitstream, the method comprising:
producing coefficients for the tensor using a plurality of basis vectors, the coefficients forming one feature map for each basis vector of the plurality of basis vectors;
producing an assignment that groups coefficients according to the respective one of the basis vector for the coefficients;
encoding the coefficients into a feature frame bitstream such that each group of coefficients is decoded independently; and
encoding the assignment into the bitstream and setting a subpicture arrangement based on the assignment to encode the tensor.

13. A non-transitory computer-readable storage medium which stores a program for executing a method of encoding a tensor for a single frame into a bitstream, the method comprising:
producing coefficients for the tensor using a plurality of basis vectors, the coefficients forming one feature map for each basis vector of the plurality of basis vectors;
producing an assignment that groups coefficients according to the respective one of the basis vector for the coefficients;
encoding the coefficients into a feature frame bitstream such that each group of coefficients is decoded independently; and
encoding the assignment into the bitstream and setting a subpicture arrangement based on the assignment to encode the tensor.

14. A system comprising:
a memory; and
a processor, wherein the processor is configured to execute code stored on the memory for implementing a method of encoding a tensor for a single frame into a bitstream, the method comprising:
producing coefficients for the tensor using a plurality of basis vectors, the coefficients forming one feature map for each basis vector of the plurality of basis vectors;
producing an assignment that groups coefficients according to the respective one of the basis vector for the coefficients;
encoding the coefficients into a feature frame bitstream such that each group of coefficients is decoded independently; and
encoding the assignment into the bitstream and setting a subpicture arrangement based on the assignment to encode the tensor.

15. A decoder for decoding a tensor for a single frame from a bitstream, the decoder configured to:
decode an assignment that maps an arrangement of independently coded regions of a picture to a plurality of groups of basis vectors;
decode a feature frame from the bitstream wherein the feature frame contains a plurality of independently coded regions, each region containing coefficients corresponding to one or more basis vectors of a plurality of basis vectors according to the assignment;
obtain coefficients from the decoded feature frame by inverse quantising samples from the feature frame; and
produce the decoded tensor using the basis vectors and the decoded coefficients.

16. A non-transitory computer-readable storage medium which stores a program for executing a method of decoding a tensor for a single frame from a bitstream, the method comprising:
decoding an assignment that maps an arrangement of independently coded regions of a picture to a plurality of groups of basis vectors;
decoding a feature frame from the bitstream wherein the feature frame contains a plurality of independently coded regions, each region containing coefficients corresponding to one or more basis vectors of a plurality of basis vectors according to the assignment;
obtaining coefficients from the decoded feature frame by inverse quantising samples from the feature frame; and
producing the decoded tensor using the basis vectors and the decoded coefficients.

17. A system comprising:
a memory; and
a processor, wherein the processor is configured to execute code stored on the memory for implementing a method of decoding a tensor for a single frame from a bitstream, the method comprising:
decoding an assignment that maps an arrangement of independently coded regions of a picture to a plurality of groups of basis vectors;
decoding a feature frame from the bitstream wherein the feature frame contains a plurality of independently coded regions, each region containing coefficients corresponding to one or more basis vectors of a plurality of basis vectors according to the assignment;
obtaining coefficients from the decoded feature frame by inverse quantising samples from the feature frame; and
producing the decoded tensor using the basis vectors and the decoded coefficients.
